(19) United States
(12) Patent Application Publication
(10) Pub. No.: US 2026/0193977 A1
(43) Pub. Date: Jul. 9, 2026

(54) PITTING DETECTION AND RESIDUAL STRENGTH CALCULATION METHODS AND SYSTEMS FOR MULTI-ARM CALIPER LOGGING DATA

(71) Applicant: SOUTHWEST PETROLEUM UNIVERSITY, Chengdu (CN)

(72) Inventors: Zhi ZHANG, Chengdu (CN); Xianghui WANG, Chengdu (CN); Duo HOU, Chengdu (CN); Jian DING, Chengdu (CN); Yuanjin ZHAO, Chengdu (CN)

(73) Assignee: SOUTHWEST PETROLEUM UNIVERSITY, Chengdu (CN)

(21) Appl. No.: 19/441,794

(22) Filed: Jan. 6, 2026

(30) Foreign Application Priority Data
Jan. 6, 2025 (CN) 202510014362.4

(51) Int. Cl. E21B 47/00; E21B 47/002; G01B 3/38; G06T 5/70; G06T 7/00; G06T 7/50; G06T 7/60; G06T 11/26; G06T 17/30

(52) U.S. Cl. CPC E21B 47/006; E21B 47/002; G01B 3/38; G06T 5/70; G06T 7/0002; G06T 7/50; G06T 7/60; G06T 11/26; G06T 17/30; G06T 2207/10016; G06T 2207/20081; G06T 2207/20084; G06T 2207/30181; G06T 2210/12

(57) ABSTRACT

Provided is a pitting detection and residual strength calculation methods and systems for multi-arm caliper logging data. The method includes the following steps. Converting the multi-arm caliper logging data into a three-dimensional model, and performing data cleaning and batch projection transformation to obtain a planar image sequence; classifying and annotating a pitting region in an image according to a pitting type standard; employing an improved YOLOv8 intelligent image detection model, adding a bottleneck attention module to enhance focus on the pitting region, using a batch channel normalization function to optimize a training effect, and employing an improved bounding box regression manner Shape-IoU to replace a complete intersection over union loss function; training an annotated image sequence using the improved BBI-YOLOv8 intelligent image detection model to obtain an intelligent pitting detection model; and calculating a residual strength based on a pitting type, an opening length, an average depth, and a stress concentration factor of the pitting region.

### CROSS-REFERENCE TO RELATED APPLICATIONS

This application claims priority to Chinese Patent Application No. 202510014362.4, filed on Jan. 6, 2025, the contents of which are hereby incorporated by reference.

### TECHNICAL FIELD

The present disclosure generally relates to a field of oil and gas field engineering technology, and in particular to a pitting detection and residual strength calculation method and system for multi-arm caliper logging data.

### BACKGROUND

A tubing string in an oil well is often affected by various factors such as geological, engineering, and chemical environments during long-term service, leading to the widespread occurrence of corrosion. Especially in complex environments, the uneven scale and distribution of corrosion defects can accelerate the corrosion rate, causing problems such as perforation, collapse, and cracking of the tubing string. This further affects the structural integrity of the tubing string, shortens its service life, and seriously threatens the safety of field operations. In oil and gas field operations, tubing string corrosion is one of the main causes of downhole equipment failure and safety accidents. According to relevant data statistics from Japan's refining and petrochemical industry, the proportion of corrosion failures in completion tubing strings in sulfur-containing environments is as high as 73.8%, and stress corrosion cracking is as high as 41.6%. Therefore, timely and accurate identification of corrosion defects in the tubing string, prediction of residual strength, and formulation of reasonable control measures are of crucial importance for ensuring the safety of oil and gas wells and extending the service life of the tubing string.

Existing methods for analyzing caliper logging data mainly rely on manual visual inspection, expert judgment, or analysis methods based on statistical features. Specifically, traditional corrosion detection typically involves manual analysis of caliper logging data, manually delineating corrosion regions and assessing the type and severity of corrosion. This method is not only time-consuming and labor-intensive but is also easily influenced by the experience and judgment of the operator, leading to subjective and inconsistent results. It is difficult to achieve large-scale, high-efficiency real-time monitoring. Furthermore, existing pitting detection techniques mostly rely on standards or expert systems for evaluation. This method has limited data processing capability and automation, lacks efficient image processing and deep learning technologies, and struggles to handle complex pitting morphology and large-scale data processing requirements.

Therefore, it is desirable to provide a pitting detection and residual strength calculation method and system for multi-arm caliper logging data, which can improve corrosion detection efficiency, reduce subjective errors, refine analysis granularity, and achieve automated large-scale detection.

### SUMMARY

One or more embodiments of the present disclosure provide a pitting detection and residual strength calculation method for multi-arm caliper logging data, comprising the following steps: S1, converting the multi-arm caliper logging data into a three-dimensional model; S2, performing data cleaning on the three-dimensional model, and performing batch projection transformation to obtain a planar image sequence; S3, classifying and annotating pitting regions in the planar image sequence according to pitting types to obtain an annotated planar image sequence; S4, introducing a you only look once vertion 8 (YOLOv8) intelligent image detection model, adding a bottleneck attention module (BAM) for enhancing network attention to the pitting regions, replacing a batch normalization function (BN) in the YOLOv8 intelligent image detection model with a batch channel normalization function (BCN) to improve training effect, and replacing a complete intersection over union loss function (CIOU) in the YOLOv8 intelligent image detection model with an improved bounding box regression manner Shape-aware Intersection over Union (Shape-IoU) to improve detection capability for irregular pitting regions, thereby obtaining an improved Bottleneck Attention Module-Batch Channel Normalization-Shape-IoU (BBI)-YOLOv8 intelligent image detection model; S5, training the improved BBI-YOLOv8 intelligent image detection model using the annotated planar image sequence to obtain an intelligent pitting detection model; and S6, calculating residual strengths of the pitting regions according to the pitting types, an opening length, an average depth, and a stress concentration factor K of each of the pitting regions.

One or more embodiments of the present disclosure provide an intelligent pitting detection system for implementing the pitting detection and residual strength calculation method, wherein the intelligent pitting detection system comprises: a data conversion module configured to convert the multi-arm caliper logging data into the three-dimensional model; a data processing module configured to perform the data cleaning on the three-dimensional model and perform the batch projection transformation to obtain the planar image sequence; a classification and annotation module configured to classify and annotate the pitting regions in the planar image sequence according to the pitting types to obtain the annotated planar image sequence; an intelligent detection module configured to introduce the YOLOv8 intelligent image detection model, add the BAM, replace the BN with the BCN, and replace the CIOU in the YOLOv8 intelligent image detection model with the bounding box regression manner Shape-IoU to improve the detection capability for the irregular pitting regions, thereby obtaining the improved BBI-YOLOv8 intelligent image detection model; a model training module configured to train the annotated planar image sequence using the improved BBI-YOLOv8 intelligent image detection model to obtain the intelligent pitting detection model; and a strength calculation module configured to calculate the residual strengths of the pitting regions according to the pitting types, the opening length, the average depth, and the stress concentration factor K of each of the pitting regions.

Compared with the prior art, advantages of the present disclosure are as follows:

1. The present disclosure utilizes the improved BBI-YOLOv8 intelligent image detection model. Through automated image recognition technology, the present disclosure quickly and accurately identifies and classifies a pitting region in caliper logging data, significantly improving the efficiency of pitting detection.

2. The present disclosure reduces complexity and subjective errors of manual operations through automated processing of the intelligent model, improving the accuracy and consistency of detection results.

3. The present disclosure directly extracts pitting region information from logging data through the intelligent detection model. Combined with parameters such as a stress concentration factor (K), the present disclosure quickly calculates a residual strength of a tubing string, significantly improving the efficiency of tubing string strength verification. The method is capable of processing a large amount of data in a relatively short time, meeting real-time requirements in actual production.

4. The present disclosure establishes a scientific residual strength calculation model by combining a pitting type, an opening length, a depth, and a stress concentration factor (K) of a pitting region. This provides a more precise evaluation basis for corrosion integrity management of a tubing string, and can provide effective support for safety control and risk management of oil and gas extraction operations.

5. By evaluating a residual strength of a tubing string in real time and accurately, the present disclosure can provide a theoretical basis for predicting a safe service life of the tubing string. Using this method, potential corrosion defects and risks of a tubing string can be discovered in advance. Effective control measures can then be taken in advance to avoid tubing string failure or occurrence of sudden accidents.

### BRIEF DESCRIPTION OF THE DRAWINGS

To more clearly illustrate the technical solutions in the embodiments of the present disclosure, the drawings used in the embodiments are briefly introduced below. It should be understood that the following drawings only show some embodiments of the present disclosure and therefore should not be considered as limiting the scope of the present disclosure.

FIG. 1 is a block diagram of an intelligent pitting detection system according to some embodiments of the present disclosure.

FIG. 2 is a flowchart of a pitting detection and residual strength calculation method for multi-arm caliper logging data according to some embodiments of the present disclosure.

FIG. 3 is a schematic diagram of a pitting detection and residual strength calculation method for multi-arm caliper logging data according to some embodiments of the present disclosure.

FIG. 4 is a schematic diagram illustrating collecting the multi-arm caliper logging data by a 40-arm caliper according to some embodiments of the present disclosure.

FIG. 5 is a flowchart illustrating a process of determination of the training set based on caliper logging data according to some embodiments of the present disclosure.

FIG. 6 is a diagram illustrating implementation of three-dimensional imaging in space using a Non-Uniform Rational B-Splines (NURBS) curve interpolation method according to some embodiments of the present disclosure.

FIG. 7 is a top view of a caliper on a wellbore cross-section according to some embodiments of the present disclosure. In the figure, (a) is the top view, and (b) is a simplified geometric diagram.

FIG. 8 is a diagram of auxiliary lines for FIG. 7(b) according to some embodiments of the present disclosure.

FIG. 9 is a three-dimensional imaging map of a corrected radius data sequence according to some embodiments of the present disclosure.

FIG. 10 is a pitting-depth heatmap according to some embodiments of the present disclosure.

FIG. 11 is a PyTorch framework diagram of YOLOv8 according to some embodiments of the present disclosure.

FIG. 12 is a framework flowchart of a CBS (Conv2d-BatchNorm-SiLU) module according to some embodiments of the present disclosure.

FIG. 13 is a framework flowchart of a Cross Stage Partial-inspired feature fusion (C2f) module according to some embodiments of the present disclosure.

FIG. 14 is a framework flowchart of a Spatial Pyramid Pooling-Fas (SPPF) module according to some embodiments of the present disclosure.

FIG. 15 is a diagram of a simplified model of a residual strength of tubulars according to some embodiments of the present disclosure.

FIG. 16 is a diagram illustrating pitting shapes according to some embodiments of the present disclosure, where (a) is a deep hemispherical pitting defect, (b) is a shallow hemispherical pitting defect, and (c) is a hemispherical pitting defect.

FIG. 17 is a classification annotation diagram of a pitting-depth heatmap according to some embodiments of the present disclosure.

FIG. 18 is a diagram of an overall architecture of BBI-YOLOv8 according to some embodiments of the present disclosure.

FIG. 19 is a basic structure diagram of BAM according to some embodiments of the present disclosure.

FIG. 20 is a normalization flowchart of BCN for a feature image according to some embodiments of the present disclosure.

FIG. 21 is a schematic diagram of Shape-IoU regression according to some embodiments of the present disclosure.

FIG. 22 is a schematic diagram illustrating variation of a stress concentration factor with pitting depth and opening length according to some embodiments of the present disclosure, where (a) is deep hemispherical, (b) is hemispherical, and (c) is shallow hemispherical.

FIG. 23 is a diagram illustrating residual external collapse resistance strength and residual internal pressure resistance strength of each pitting region in sample images according to some embodiments of the present disclosure.

### DETAILED DESCRIPTION

To make the objectives, technical solutions, and advantages of the present disclosure clearer, the present disclosure is described in further detail below with reference to the accompanying drawings and by listing embodiments.

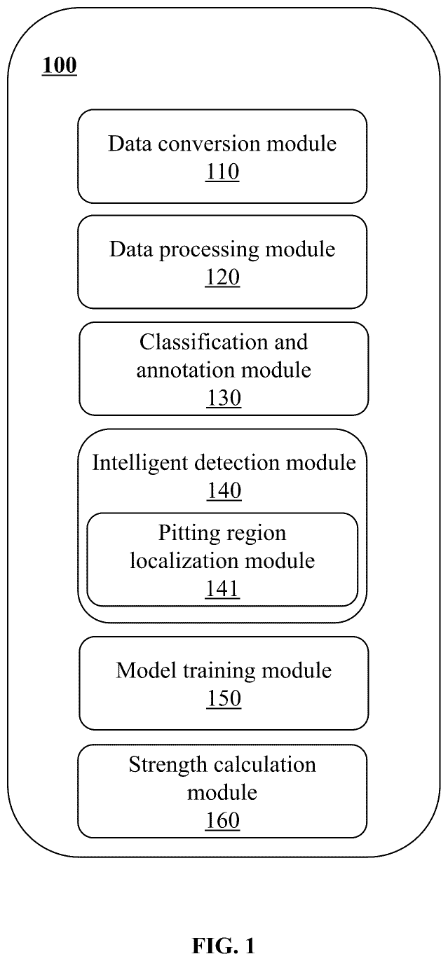

FIG. 1 is a block diagram of an intelligent pitting detection system according to some embodiments of the present disclosure.

In some embodiments, as shown in FIG. 1, the intelligent pitting detection system 100 may include a data conversion module 110, a data processing module 120, a classification and annotation module 130, an intelligent detection module 140, a model training module 150, and a strength calculation module 160.

In some embodiments, the data conversion module 110, the data processing module 120, the classification and annotation module 130, the intelligent detection module 140, the model training module 150, and the strength calculation module 160 may be integrated into a processor and communicatively connected to the processor.

In some embodiments, the processor may include a central processing unit (CPU), an application-specific integrated circuit (ASIC), an application-specific instruction set processor (ASIP), a physics processing unit (PPU), a digital signal processor (DSP), a processor, a microprocessor unit, a reduced instruction set computer (RISC), a microprocessor, etc., or any combination thereof. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an internal cloud, a multi-layer cloud, etc., or any combination thereof.

In some embodiments, the data conversion module 110 may be configured to convert multi-arm caliper logging data into a three-dimensional model.

In some embodiments, the data conversion module 110 may be further configured to map the multi-arm caliper logging data into a three-dimensional spatial coordinate system and generate a preliminary three-dimensional caliper model.

In some embodiments, the data processing module 120 may be configured to perform data cleaning on the three-dimensional model and perform batch projection transformation to obtain a planar image sequence.

In some embodiments, the classification and annotation module 130 may be configured to classify and annotate pitting regions in the planar image sequence according to pitting types to obtain the annotated planar image sequence.

In some embodiments, the intelligent detection module 140 may be configured to introduce a YOLOv8 intelligent image detection model, add a BAM, replace a BN with a BCN, and replace a CIOU in the YOLOv8 intelligent image detection model with the bounding box regression manner Shape-IoU to improve detection capability for the irregular pitting regions, thereby obtaining an improved BBI-YOLOv8 intelligent image detection model.

In some embodiments, the intelligent detection module 140 further includes a pitting region localization module 141 for accurately identifying the pitting regions in images of the planar image sequence and improving robustness of the improved BBI-YOLOv8 intelligent image detection model in complex backgrounds.

In some embodiments, the model training module 150 may be configured to train the annotated planar image sequence using the improved BBI-YOLOv8 intelligent image detection model to obtain an intelligent pitting detection model.

In some embodiments, the strength calculation module 160 may be configured to calculate residual strengths of the pitting regions according to the pitting type, an opening length, an average depth, and a stress concentration factor K of each of the pitting regions.

In some embodiments, the strength calculation module 160 may be further configured to calculate the stress concentration factor K of each pitting region of the pitting regions according to a detection result of the each pitting region, wherein the detection result includes the pitting type, the opening length, and depth information; calculate the residual strengths of the pitting regions according to the pitting types and geometrical characteristics in combination with a mechanical model; statistically analyze the residual strengths of the pitting regions to obtain a residual strength of an entire tubing string; compare the residual strength of the entire tubing string with an original strength of the entire tubing string to evaluate a corrosion degree and safety of the entire tubing string; and provide a calculation result of the residual strength for tubing string corrosion evaluation and decision support.

In some embodiments, the intelligent pitting detection system 100 may further include an expert support module, a data management module, an image generation module, a BBI-YOLOv8 intelligent pitting detection block, and a residual strength calculation module.

In some embodiments, an expert user may receive the multi-arm caliper logging data collected by a multi-arm caliper via the expert support module, set a format and a scale of the multi-arm caliper logging data, perform preliminary statistics, interpretation, and analysis on the multi-arm caliper logging data and output results to the data management module; receive a calculation result of residual strength of tubulars (including tubing and casing), and predict and manage a safe service life and a critical load of the tubulars based on the calculation result.

For example, the expert support module may receive a signal transmitted by the multi-arm caliper, convert the signal into structured features, and transmit the structured features to the data management module. After receiving the calculation result of residual strength from the residual strength calculation module, the expert support module may predict a safe service life and provide risk warnings for a corresponding tubulars based on the residual strength and relevant standards, and further provide a management and control solution considering corrosion integrity of the tubulars.

In some embodiments, the data management module may be configured to receive the multi-arm caliper logging data for data cleaning and data preprocessing, and allocate the structured features received from the expert support module according to requirements of other modules.

It can be understood that original multi-arm caliper logging data may contain errors due to instrument or human operation. Failure to address these errors will lead to misjudgments in subsequent modules. Therefore, data cleaning and data preprocessing are required to reduce model training time and improve model prediction accuracy. After data cleaning and data preprocessing, the multi-arm caliper logging data is allocated according to requirements of other modules. The data management module always maintains normality of the data.

In some embodiments, the image generation module may be configured to organize and collect multi-arm caliper logging data measured by a field multi-arm caliper, convert the multi-arm caliper logging data into the planar image sequence, and label the pitting regions in images of the planar image sequence.

For example, the image generation module may organize and collect multi-arm caliper logging data measured by the field multi-arm caliper, convert the multi-arm caliper logging data into the spatial coordinate sequence, use color linear transformation to reflect radius sequence variation, establish the three-dimensional model in space based on NURBS curve interpolation, perform data cleaning on the three-dimensional model, and then perform projection transformation to generate a series of pitting-depth heatmaps with equal side lengths and equal vertical depth steps (i.e., the planar image sequence).

In some embodiments, the BBI-YOLOv8 intelligent pitting detection block may be configured to improve the YOLOv8 intelligent image detection model, input the annotated planar image sequence into the YOLOv8 intelligent image detection model for training, and obtain the BBI-YOLOv8 intelligent image detection model capable of performing pitting region division and type identification on multi-arm caliper logging data in real time.

For example, the BBI-YOLOv8 intelligent pitting detection block may divide pitting detection on an inner wall of the tubulars into two parts. First, each pitting region is divided. Then, a type of a pitting shape of each divided region is identified.

It can be understood that the YOLOv8 intelligent image detection model may divide and identify pitting regions. However, before that, original image samples need to be labeled to train the YOLOv8 intelligent image detection model. Therefore, rules for dividing pitting regions and types need to be formulated, and an improved BBI-YOLOv8 intelligent image detection model (also referred to as the BBI-YOLOv8 model) adapted to the rules needs to be formulated to improve identification accuracy.

In some embodiments, the residual strength calculation module may be configured to reference the stress concentration factor K to approximate different types of pitting regions, calculate the stress concentration factor K for each pitting region based on the type, and further calculate the residual strength of the entire tubing string.

It can be understood that the processor may, based on basic parameters of the tubulars and the residual strength calculation module, obtain distribution diagrams of variation patterns of the stress concentration factor K with pitting depth and opening length for three pitting shapes. Results of pitting detection include the pitting shape, length, width, and depth information. Therefore, after the BBI-YOLOv8 model obtains a pitting target image, the residual strength of the tubulars may be further calculated based on the identification result. For this purpose, an output result of the intelligent pitting detection model is improved so that each pitting region divided by the model can include complete corrosion information of a pitting target, such as length, width, and depth. Then, the residual strength of the tubing string for each pitting region is further converted based on the pitting shape.

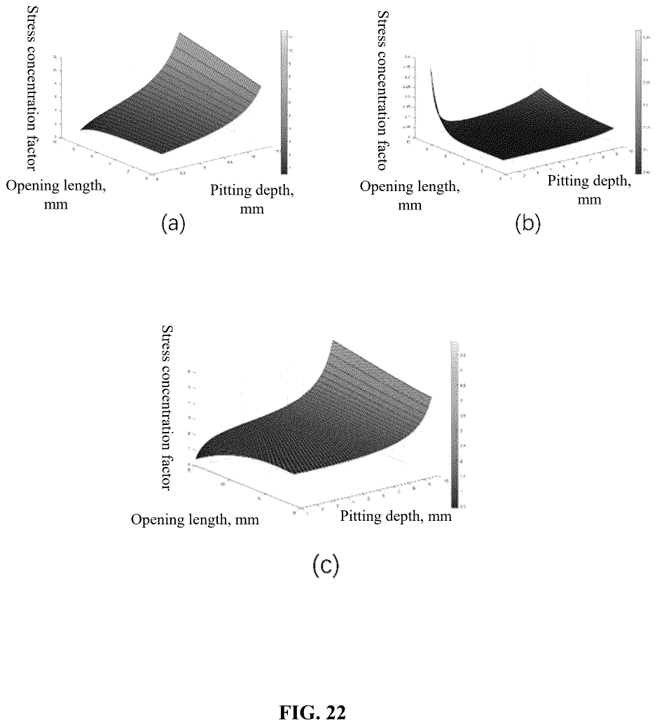

FIG. 22 is a schematic diagram illustrating variation of a stress concentration factor with pitting depth and opening length according to some embodiments of the present disclosure, where (a) is deep hemispherical, (b) is hemispherical, and (c) is shallow hemispherical.

As shown in FIG. 22, the stress concentration factor K generally shows an increasing trend with an increase in pitting depth and opening length.

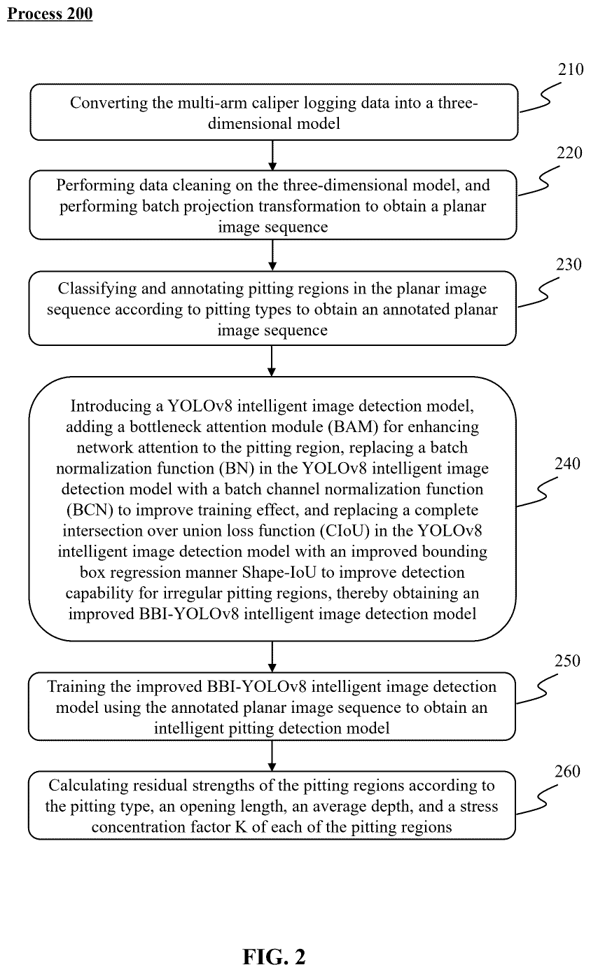

FIG. 2 is a flowchart of a pitting detection and residual strength calculation method for multi-arm caliper logging data according to some embodiments of the present disclosure.

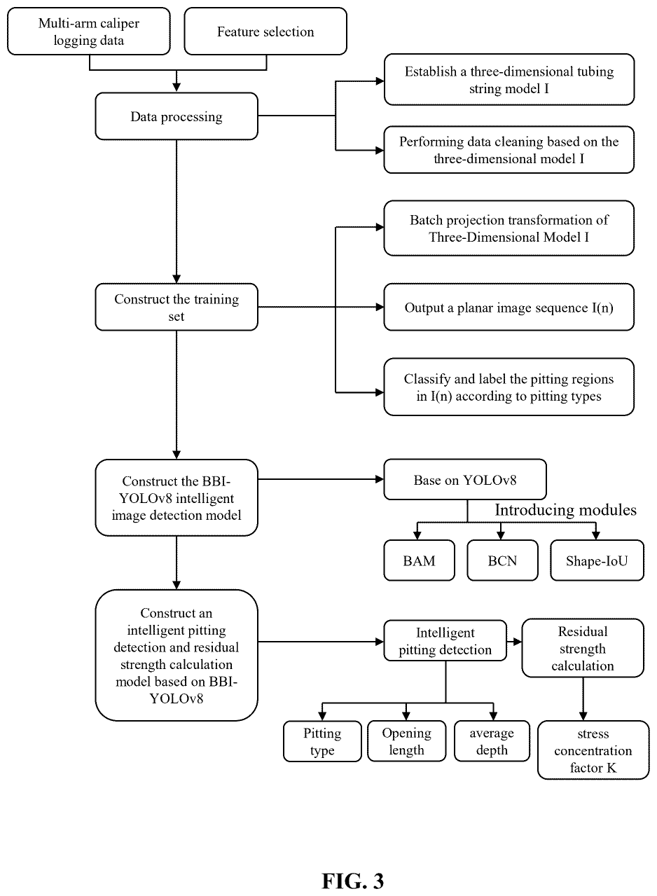

FIG. 3 is a schematic diagram of a pitting detection and residual strength calculation method for multi-arm caliper logging data according to some embodiments of the present disclosure.

In some embodiments, as shown in FIGS. 2 and 3, a process 200 may be executed by a processor. The process 200 includes step 210-step 260.

In 210, converting the multi-arm caliper logging data into a three-dimensional model.

The multi-arm caliper logging data refers to data used to describe a geometric profile of an oil well.

In some embodiments, the multi-arm caliper logging data may include distance values from a center of a multi-arm caliper to an inner wall of the oil well.

The oil well refers to a well used to carry petrochemical products. The oil well includes tubulars. The multi-arm caliper logging data may also be data describing a geometric profile of the tubulars. The multi-arm caliper refers to a device used to obtain multi-arm caliper logging data. In some embodiments, one multi-arm caliper may include a plurality of measurement arms.

For example, the multi-arm caliper logging data may be a matrix. Rows of the matrix represent measurement depths of the oil well. Columns of the matrix represent measurement arms of the multi-arm caliper. Elements in the matrix represent distances from the center of the multi-arm caliper to the inner wall of the oil well obtained by corresponding measurement arms at corresponding depths.

In some embodiments, the multi-arm caliper logging data may further include tubulars calipers, a maximum tubulars caliper, a minimum tubulars caliper, an average tubulars caliper, remaining wall thicknesses, wellbore defects, deformation locations, etc.

It should be noted that multi-arm caliper logging is a logging method for measuring a geometric shape of an oil wellbore. The multi-arm caliper is lowered into a bottom of the oil well and moved upward along the center of the oil well while slowly rotating measurement arms. A radius of a oil well wall at each position is measured one by one through contact between the measurement arms and the inner wall, thereby confirming damage conditions of a tubing string such as corrosion, deformation, and scaling. Common types of the multi-arm caliper include an X-Y caliper, a micro caliper, and specifications of 8 arms, 18 arms, 38 arms, 40 arms, and 60 arms. The multi-arm caliper has high measurement accuracy and is capable of measuring corrosion depths at various locations on the inner wall of the tubulars.

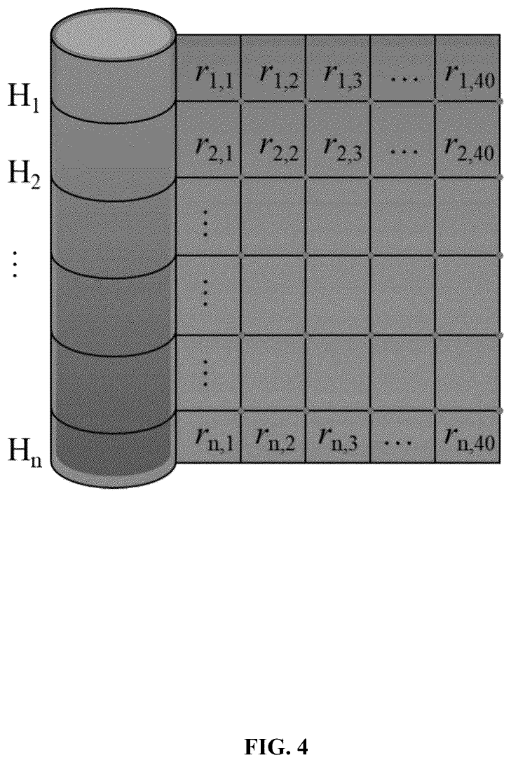

FIG. 4 is a schematic diagram illustrating collecting the multi-arm caliper logging data by a 40-arm caliper according to some embodiments of the present disclosure.

In some embodiments, as shown in FIG. 4, H represents a series of the caliper measuring one circumference, and r is a series of distances from the axis to the oil well wall at equal radian. All the distances constitute an n×40 matrix that records caliper information for an entire well section.

In some embodiments, the processor may perform caliper measurement via the multi-arm caliper to obtain radius values from the center of the multi-arm caliper to the inner wall of an oil well detected by the plurality of measurement arms. The processor may use the radius values of the inner wall of the oil well as tubulars caliper values. The processor may perform statistics (e.g., mathematical statistics) based on the tubulars caliper values to obtain the maximum tubulars caliper, the minimum tubulars caliper, and the average tubulars caliper. The processor may determine a remaining wall thickness of the tubulars based on a difference between the maximum tubulars caliper and the minimum tubulars caliper. The processor may arrange the tubulars caliper values sequentially according to cross-sectional angles. A position where a variation in the tubulars caliper values is relatively large (e.g., a difference greater than 0.5 mm compared to a tubulars caliper at an adjacent angle at the same depth) may be determined as a wellbore wall defect. A portion where the tubulars caliper values change continuously with the measurement arm angle at the same depth may be determined as a deformation portion. Data obtained from all the aforementioned measurements and calculations may be used as the multi-arm caliper logging data.

The three-dimensional model refers to a model that maps multi-arm caliper logging data into a three-dimensional spatial coordinate system to describe an internal shape of the oil well.

In some embodiments, the processor may map original caliper logging data into a three-dimensional spatial coordinate system and generate a preliminary three-dimensional caliper model.

The caliper logging data may also be referred to as the multi-arm caliper logging data.

The three-dimensional caliper model may also be referred to as the three-dimensional model.

In some embodiments, the processor may map the original caliper logging data into the three-dimensional spatial coordinate system and generate the preliminary three-dimensional caliper model in various ways.

For example, the processor may obtain coordinates of the original caliper logging data in the three-dimensional spatial coordinate system using the following formula:

$${[ x , y , z ]}_{i j} = [ {R}_{i j} \times cos ( j \frac{2 π}{40} ) , {R}_{i j} \times sin ( j \frac{2 π}{40} ) , {H}_{i} ]$$

In the formula: Rᵢⱼ is the radius measured by the caliper at the i-th row and j-th column, x is a lateral displacement of element Rᵢⱼ in space in millimeters, y is a longitudinal displacement of element Rᵢⱼ in space in millimeters, z is a vertical depth in meters, Hᵢ is the vertical depth of the multi-arm caliper relative to the wellhead of the oil well during measurement corresponding to the i-th row, and [x, y, z]ᵢⱼ is coordinates of the caliper logging data in the three-dimensional spatial coordinate system.

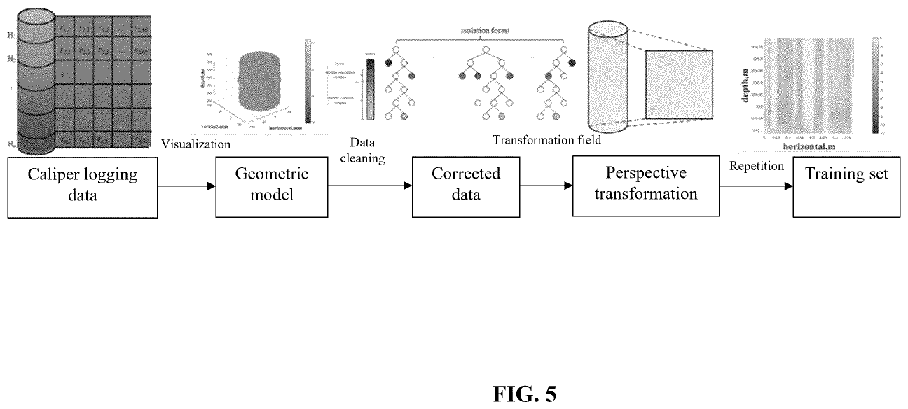

As shown in FIG. 5, after obtaining coordinates of all the caliper logging data in the three-dimensional spatial coordinate system, the processor may use a modeling tool (e.g., MATLAB) to achieve three-dimensional imaging of the caliper logging data in three-dimensional space based on a parametric curve fitting method (e.g., a NURBS curve interpolation method).

In some embodiments of the present disclosure, mapping the original caliper logging data into the three-dimensional spatial coordinate system and generating the preliminary three-dimensional caliper model can obtain a true morphology of the wellbore wall without using additional instruments. This avoids secondary logging costs. Abnormalities caused by local corrosion, elliptical deformation, or tool eccentricity are immediately presented. This provides a basis for directional correction in subsequent data cleaning.

In 220: performing data cleaning on the three-dimensional model, and performing batch projection transformation to obtain a planar image sequence.

The data cleaning refers to an operation of correcting abnormal values in the three-dimensional model that deviate from a true wellbore wall of the oil well.

In some embodiments, the processor may perform data cleaning on the three-dimensional model in various ways.

For example, the processor may mark coordinate points in the three-dimensional model that are outliers or exceed a wall thickness range of the oil well as abnormal and remove them. The processor may obtain the radius values of four arms at 0°, 90°, 180°, and 270° at the same depth cross-section and calculate true center coordinates of the oil well according to the sine law. The processor may calculate an offset of the multi-arm caliper center relative to the true center of the oil well. The processor may perform coordinate translation on all radius values using the offset (e.g., if the radius end coordinate is farther from the true center, the radius end coordinate may be subtracted by the offset for correction; if the radius end coordinate is closer to the true center, the radius end coordinate may be added with the offset for correction). The processor may then recalculate distances from the radius end coordinates to the true center to obtain a corrected radius sequence. Simultaneously, the processor may perform NURBS curve interpolation on the corrected radius sequence to eliminate burrs, resulting in a continuous three-dimensional wellbore wall surface.

It is understandable that converting the multi-arm caliper logging data into the three-dimensional model allows for visualizing the data to identify errors in the original data. Outlier detection and pose correction are used to complete data cleaning.

In some embodiments, the data cleaning includes removing noise data, abnormal values, and measurement errors from the three-dimensional model, and performing smoothing on the three-dimensional model.

The noise data refers to random jump data of radius measurement values in the three-dimensional model caused by instrument vibration, electromagnetic interference, sensor drift, or instantaneous friction within the well.

In some embodiments, the processor may determine a sliding residual based on the multi-arm caliper logging data at the same depth. The processor may determine the multi-arm caliper logging data corresponding to the sliding residual less than a preset residual threshold as the noise data. The preset residual threshold may be preset by a technician based on experience.

In some embodiments, the processor may replace the noise data with the multi-arm caliper logging data obtained by the measurement arms at the same depth.

The abnormal value refers to a radius data point in the three-dimensional model that deviates by more than three times the standard deviation or is determined to be outlying.

In some embodiments, the standard deviation may be obtained by the processor through statistical analysis based on a radius value at a current angle of an oil well cross-section, other radius values within the same depth cross-section, and radius values at corresponding angle of adjacent depth cross-sections.

In some embodiments, the processor may determine whether a current radius value is an outlier radius data point using an isolation forest algorithm.

In some embodiments, the processor may delete the abnormal value(s). The processor may perform linear interpolation based on multi-arm caliper logging data obtained by two measurement arms at the same depth as that of the abnormal value. The processor may then supplement a result to the position where the abnormal value was deleted.

The measurement error refers to systematic errors and random errors generated due to instrument miscentering, wellbore axis inclination, mechanical arm wear, sensor zero drift, temperature drift, or depth encoder misalignment, etc.

In some embodiments, the processor may automatically detect and correct systematic errors through sine verification, zero drift calibration, and depth comparison. The processor may then use multi-arm caliper logging data within the same depth cross-section that has been corrected for systematic errors to calculate a three-times standard deviation to eliminate random errors, thereby completing identification and removal of measurement error.

The smoothing refers to an operation of eliminating random jumps and burrs in measured values of the radius of the oil well to obtain continuous wellbore wall profile data.

In some embodiments, the processor may use the NURBS curve interpolation method to fit discrete radius points into a continuous circumferential curve. This achieves smoothing of random jumps and burrs in measured values of the radius of the oil well.

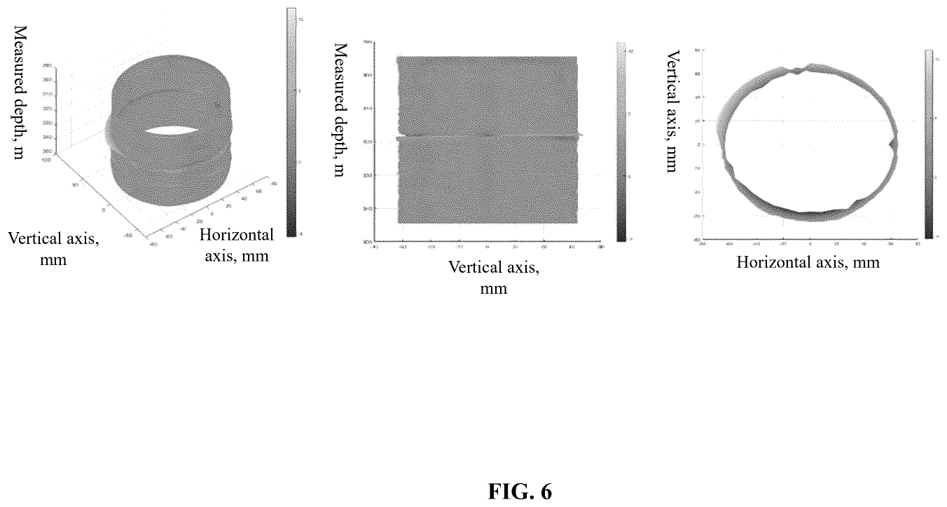

FIG. 6 is a diagram illustrating implementation of three-dimensional imaging in space using a NURBS curve interpolation method according to some embodiments of the present disclosure.

FIG. 6 shows a three-dimensional morphology of an inner wall of tubulars between 290 m and 320 m. The color in FIG. 6 represents a difference between a measured radius and a theoretical inner radius, i.e., a corrosion depth (mm). As shown in FIG. 6, the shape of the inner wall in this region is not accurate in some areas. For example, at 315 m-320 m, the left side of the inner wall is recessed and the right side protrudes, showing a significant offset. This indicates that radius values obtained from caliper measurements contains errors. Therefore, it is necessary to correct erroneous measurement data and perform data cleaning on the measurement data.

The errors occurring in caliper measurement may be divided into two categories. One category is systematic errors caused by inherent accuracy issues of the mechanical caliper itself, including insufficient sensor accuracy, product defects, mechanical arm wear, deformation, etc. This type of data requires re-measurement with replacement equipment. The other category is accidental errors caused by personnel calculation or operational mistakes, such as the instrument not being centered in the well during measurement, the instrument not being perpendicular to the wellbore axis causing tilt, or erroneous manual recording. Errors from this type of data can be avoided and corrected through methods of data analysis, calculation, and cleaning.

In some embodiments, as shown in FIG. 6, after obtaining coordinate mapping of all measurement data in three-dimensional space, MATLAB is used as a tool to achieve three-dimensional imaging in space based on the NURBS curve interpolation method.

The object of this caliper measurement is a vertical well section. Therefore, the following assumptions may be made regarding existing abnormal data:
(1) The caliper itself has no systematic errors.
(2) The tubulars has no deformation.
(3) The inner wall of the tubulars has no attachments or scaling points that reduce the radius.
(4) The caliper is always perpendicular to the wellbore axis.

When studying variation patterns of a continuous variable, outliers are typically treated as abnormal data. Therefore, an isolation forest algorithm is adopted to screen out the outliers and the abnormal values with fluctuation ranges greater than the wall thickness.

To eliminate the abnormal values generated by condition (4), it is first necessary to confirm whether current measurement data is centered. If not centered, an offset of the measurement instrument's center at the current depth needs to be determined and corrected. Finally, a radius sequence at the current depth is recalculated.

If the caliper is offset to the first quadrant, the top view of the caliper on the wellbore cross-section is as shown in FIG. 6.

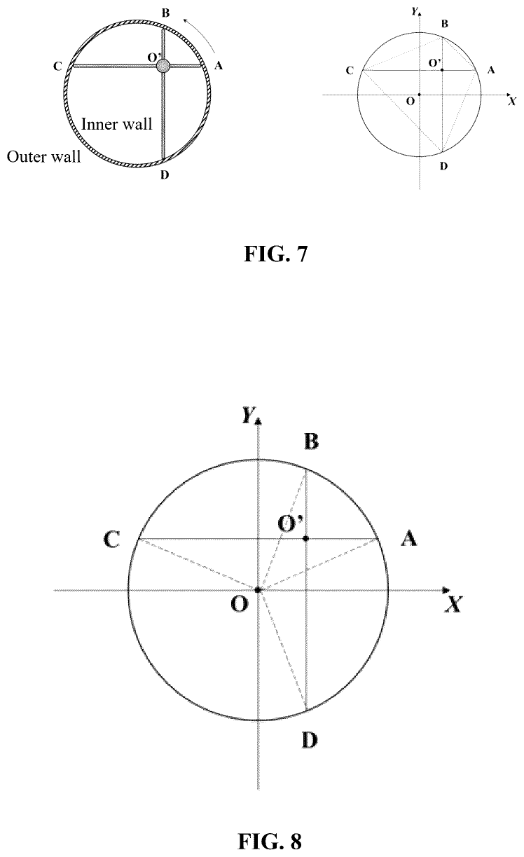

FIG. 7 is a top view of a caliper on a wellbore cross-section according to some embodiments of the present disclosure. In the figure, (a) is the top view, and (b) is a simplified geometric diagram.

In FIG. 7, O′ is an instrument center of the multi-arm caliper. Taking measurement arm A axis (sequence 1) as an initial angle and rotating counterclockwise, radii of four axes are recorded at rotations of 90° (sequence 11), 180° (sequence 21), and 270° (sequence 31), respectively. AC and BD are perpendicular to each other. Using this offset measurement data during restoration would cause measured radii AO′ and BO′ to be smaller than actual radii, and measured radii CO′ and DO′ to be larger than actual radii. To obtain a true center position, a true diameter of AC and BD is first determined. The model can be simplified to the geometrical problem shown in FIG. 7(b).

According to the law of sines, a theoretical radius of an inner wall at the four arms AC and BD is determined:

$$r = \frac{AB}{8 sin ∠ADB} + \frac{BC}{8 sin ∠BAC} + \frac{CD}{8 sin ∠CBD} + \frac{DA}{8 sin ∠DCA}$$

In the formula, lengths and angles of the straight lines are easily obtained by the Pythagorean theorem and trigonometric functions.

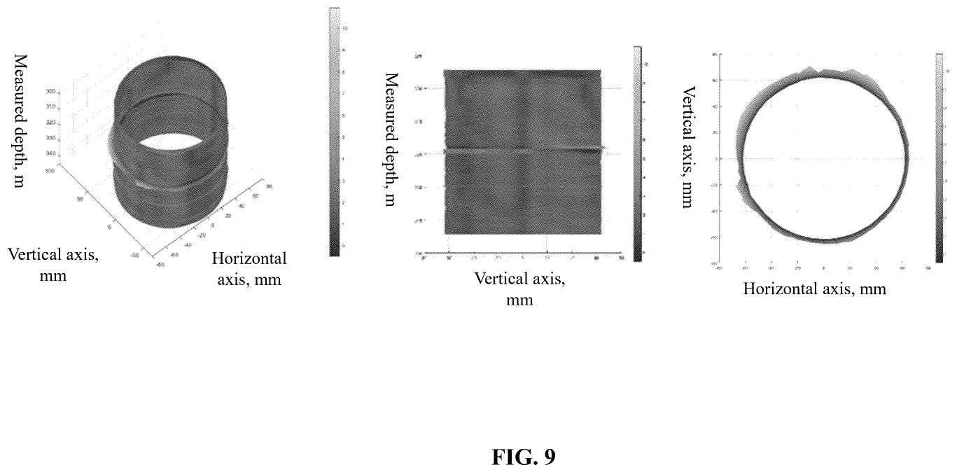

FIG. 8 is a diagram of auxiliary lines for FIG. 7(b) according to some embodiments of the present disclosure.

To determine offset values Δx and Δy between O′ and a center O, auxiliary lines are drawn as shown in FIG. 8.

In triangles AOC and BOD, the following is easily obtained:

$$\vert Δ x \vert = \sqrt{\vert {r}^{2} - {( \frac{{O}^{′} B + {O}^{′} D}{2} )}^{2} \vert}$$

$$\vert Δ y \vert = \sqrt{\vert {r}^{2} - {( \frac{{O}^{′} A + {O}^{′} C}{2} )}^{2} \vert}$$

In the formula, |Δx| and |Δy| are moduli. The positive or negative signs of Δx and Δy are determined by comparing O′A and O′B with r after confirming a quadrant of O′. The determination rule is shown in the table.

DETERMINATION CRITERIA FOR LOGGING DATA OFFSET

| Relationship | Relationship | | | |
|---|---|---|---|---|
| between | between | Determined | | |
| O′A and r | O′B and r | Quadrant | Sign of Δx | Sign of Δy |
| O′A ≤ r | O′B ≤ r | First Quadrant | + | + |
| O′A ≥ r | O′B ≤ r | Second Quadrant | − | + |
| O′A ≥ r | O′B ≥ r | Third Quadrant | − | − |
| O′A ≤ r | O′B ≥ r | Fourth Quadrant | + | − |

To correct a radius measurement sequence of an offset center back to a centered radius sequence, planar coordinates of each radius need to be determined. The planar coordinates are corrected by the offset values Δx and Δy, and then transformed back into the radius sequence by trigonometric functions. A corrected radius r′ can be expressed as:

$${r}^{′} = \sqrt{{( {R}_{i j} \times cos ( j \frac{2 π}{40} ) - Δ x )}^{2} + {( {R}_{i j} \times sin ( j \frac{2 π}{40} ) - Δ y )}^{2}}$$

A corrected true radius sequence R′ is obtained through the above data cleaning.

However, for the radius sequence, it is necessary to determine whether the mechanical caliper is offset from the center by comparing O′A and O′B with r. The data cleaning process of condition (4) is executed only when an offset is confirmed. However, because an inner wall of the tubing string has already been corroded to varying degrees, a true radius r of the inner wall in a corroded region is no longer equal to the theoretical radius of 62.0 mm. O′A and O′B cannot be compared with r without knowing whether corrosion has occurred on the inner wall. Therefore, a threshold of 0.5 mm is set. The radius sequence at this horizontal plane is corrected only when the calculation result of r at this horizontal plane is within 62±0.5 mm, indicating that the inner wall at this location is not corroded. Otherwise, a next radius sequence is selected, and the above operation is repeated until a next horizontal plane radius sequence is selected. A three-dimensional image of a finally obtained corrected radius data sequence is shown in FIG. 9.

In some embodiments, for the radius sequence after abnormal value removal, any one or any combination of moving average, median filtering, Gaussian filtering, or NURBS curve/surface fitting is used to eliminate random jumps and burrs in radius measurement values, thereby obtaining continuous multi-arm caliper logging data.

In some embodiments of the present disclosure, removing the noise data, the abnormal values, and the measurement errors from the three-dimensional model and performing smoothing on the three-dimensional model can eliminate the noise data caused by instrument vibration, electromagnetic interference, and eccentricity. This allows a remaining radius sequence to truly reflect a wellbore profile, avoids local “false pits” from being misjudged as pitting by subsequent models, preserves true corrosion edges, and makes a final residual strength result more reliable.

The projection transformation refers to a way of converting the three-dimensional model into a planar image sequence.

In some embodiments, the processor may batch-convert the corrected three-dimensional model into a two-dimensional image training set (i.e., the planar image sequence) through projection transformation.

For example, the processor may cut the corrected three-dimensional model point cloud into circumferential cross-sections at equal intervals (e.g., 0.125 m) along the well depth direction. For coordinate points of the three-dimensional model at the same depth around a circle, cylindrical expansion and pitting-depth heatmap mapping are performed to obtain the two-dimensional image. The processor may continuously slice along the well depth direction and save the images sequentially, thereby obtaining images of all depth cross-sections of an entire well section and forming the two-dimensional image training set including a plurality of images.

In some embodiments, the processor may expand the cleaned three-dimensional model into circumferential coordinates according to a circumferential angle, map the corrosion depth to pitting-depth heatmap, and stack the images row by row along the well depth direction, thereby generating a circumferential-axial two-dimensional pitting-depth heatmap planar image sequence.

The planar image sequence refers to a sequence formed by combining a plurality of two-dimensional pitting-depth heatmap images.

In some embodiments, a horizontal coordinate of each image in the planar image sequence corresponds to an expanded position of 0-360° around a circumference of the oil well, a vertical coordinate corresponds to a well depth, and a pitting-depth heatmap value of the image corresponds to the corrosion depth or the remaining wall thickness.

In some embodiments, the processor may perform data cleaning on the three-dimensional model first, then sequentially slice sections along a well depth direction, unfold the sections into a plurality of two-dimensional pitting-depth heatmap images, and combine the plurality of two-dimensional pitting-depth heatmap images to form the planar image sequence.

In some embodiments, the planar image sequence includes a plurality of images converted from measurement results of the multi-arm caliper at different depths and different angles of the oil well.

In some embodiments, the measurement results at different depths refer to measurement results obtained after the multi-arm caliper moves down along a well axis of the oil well to different depths and performs a detection each time. The different angles refer to measurement results of measurement arms of the multi-arm caliper at various angles (e.g., θⱼ=0°, 9°, 18° . . . 360°) on a cross-section of the oil well at a same depth.

FIG. 5 is a flowchart illustrating a process of determination of the training set based on caliper logging data according to some embodiments of the present disclosure.

As shown in FIG. 5, data detected at this time is inner wall data of tubulars measured by a 40-arm caliper in the Keshen gas field of the Tarim Basin. Basic information of the tubulars is shown in the table.

| Tubing inner | Tubing outer | Wall thickness | Steel | Poisson's |
|---|---|---|---|---|
| radius (mm) | radius (mm) | (mm) | grade | ratio |
| 62 mm | 73 mm | 11 mm | P110 | 0.3 |

The measurement arm uses 9° per horizontal plane as a measurement angle step and 25.0 mm as a measurement depth step to obtain the multi-arm caliper logging data from the well depth of 294.5388 m to 1004.0888 m. The measured radius sequence may be represented in the matrix form R with n rows and 40 columns, where each row represents the well depth measured by a current caliper, and each column represents a radius distance from the center of the tubulars to the oil well wall.

First, the multi-arm caliper logging data is converted into a three-dimensional model. Data visualization is used to find errors in original data. Outlier detection and pose correction are used to complete data cleaning. Finally, corrected three-dimensional image data is batch-converted into a two-dimensional image training set through projection transformation.

To map each element of the matrix to a three-dimensional coordinate in a spatial coordinate system, the following conversion may be performed:

$${[ x , y , z ]}_{i j} = [ {R}_{i j} \times cos ( j \frac{2 π}{40} ) , {R}_{i j} \times sin ( j \frac{2 π}{40} ) , {H}_{i} ]$$

In the formula: Rij is a radius length of an i-th row and a j-th column measured by the caliper, x is a lateral displacement (mm) of the element Rij in space, y is a longitudinal displacement (mm) of the element Rij in space, and z is a vertical depth (m).

It is noted that original data is a radius sequence measured by a mechanical caliper. If a projection of the radius sequence on a horizontal plane is directly used as an input image, deformation may occur due to the projection. To truly restore local corrosion and obtain accurate feature information, the tubing string may be cut open along a wellbore axis and stretched flat.

A projection transformation formula is:

$${[ x , y , z ]}_{ij} = [ j \frac{2 π r}{40} , {R}_{ij} , {H}_{i} ]$$

In the formula, r is a theoretical inner radius (mm) of the tubulars.

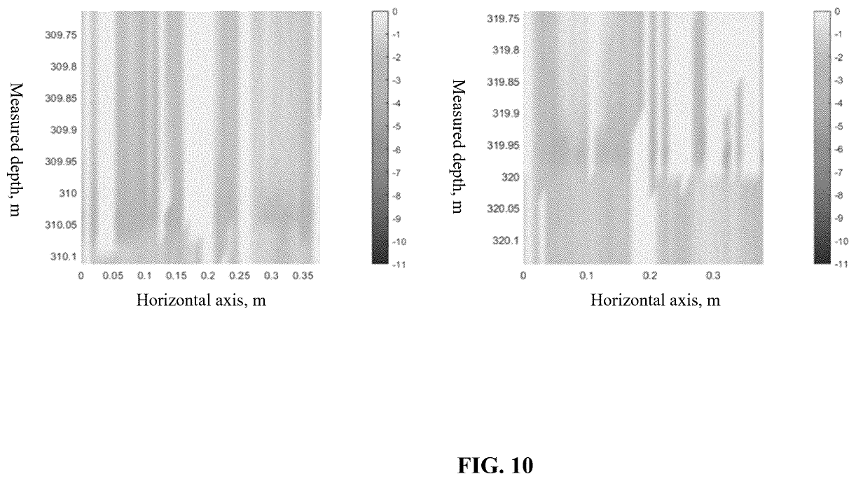

FIG. 10 is a pitting-depth heatmap according to some embodiments of the present disclosure.

In some embodiments, the two-dimensional planar image shown in FIG. 10 is an image in the planar image sequence.

A range of corrosion depth is from −11 mm to 0 mm. Therefore, a linear color change from −11 to 0 is used to represent the corrosion depth.

In some embodiments, as shown in FIG. 10, a unit length of a horizontal axis is set equal to the vertical depth to truly restore an image of a target shape, generating a series of pitting-depth heatmaps with equal vertical depth steps for an inner radius circumference of 0.400 m.

In 230, classifying and annotating pitting regions in the planar image sequence according to pitting types to obtain an annotated planar image sequence.

The pitting region refers to a connected domain in the planar image sequence where the pitting-depth heatmap value is significantly lower than that of adjacent backgrounds.

It can be understood that a lower pitting-depth heatmap value indicates a higher corrosion degree and a thinner oil well wall thickness. In an image of the planar image sequence, if a pitting-depth heatmap value of a connected domain is darker than that of surrounding connected domains (i.e., the pitting-depth heatmap value of the current connected domain is lower than that of the surrounding connected domains), it indicates that corrosion may exist in the current connected domain. If a lateral dimension of the connected domain is greater than or equal to a minimum opening diameter, and an image vertical coordinate (i.e., an oil well depth) corresponding to a lowest pitting-depth heatmap value of the connected domain is greater than or equal to a minimum depth, the connected domain is considered as the pitting region. If the lateral dimension of the connected domain is less than the minimum opening diameter, it indicates that the connected domain may be noise or pitting. If the image vertical coordinate corresponding to the lowest pitting-depth heatmap value in the connected domain is less than the minimum depth, the connected domain is considered to have a lower pitting-depth heatmap value due to scratches or shadows. The minimum opening diameter refers to a parameter used to determine whether a connected domain is noise. The minimum depth refers to a parameter used to determine whether the connected domain is a scratch region or a shadow region. In some embodiments, the minimum opening diameter and the minimum depth may be preset by the technician based on experience.

The pitting type is used to describe a shape of the pitting region. The pitting type may also be referred to as a pitting morphology.

In some embodiments, the pitting morphology is classified into shallow hemispherical, hemispherical, and deep hemispherical, and an opening length, an average depth, and the position of each pitting region are annotated.

In some embodiments, the pitting type may include shallow hemispherical, hemispherical, and deep hemispherical.

In some embodiments, the processor may classify the pitting region into shallow hemispherical, hemispherical, and deep hemispherical based on an equivalent hemispherical radius. The equivalent hemispherical radius refers to an ideal hemispherical radius where an opening area and a volume of the pitting region are equal. In some embodiments, the processor may determine the equivalent hemispherical radius based on an opening length and an average depth of any pitting region. For example, the processor may determine the equivalent hemispherical radius by the following formula:

$${r}_{1} = \frac{( {d}^{2} + 4 {r}^{2} )}{8 r}$$

r₁ represents the equivalent hemispherical radius, d represents the opening length of the pitting region, and r represents the average depth of the pitting region.

It can be understood that if the average depth of the pitting region is less than the equivalent hemispherical radius, the pitting region is considered shallow hemispherical. If the average depth of the pitting region is equal to the equivalent hemispherical radius, the pitting region is considered hemispherical. If the average depth of the pitting region is greater than the equivalent hemispherical radius, the pitting region is considered deep hemispherical.

The opening length refers to a lateral dimension of a pitting region on an image.

In some embodiments, the processor may use a maximum lateral dimension of the pitting region on an image as the opening length.

The average depth refers to an average value of oil well depths corresponding to all pitting-depth heatmap values of the pitting region.

The position of the pitting region refers to coordinates of the pitting region in an image.

In some embodiments, for each image in the planar image sequence, the processor may first detect the pitting region and generate a minimum bounding rectangle using the BBI-YOLOv8 intelligent image detection model, use a width of the rectangle as the opening length, use an average of pitting-depth heatmap depth values within the region as the average depth, use pixel coordinates of a center of the rectangle and a corresponding well depth as the position, determine the pitting type based on the opening length and the average depth, and draw the position, the pitting type, and the corresponding opening length and average depth on a corresponding region of the image to complete automatic annotation.

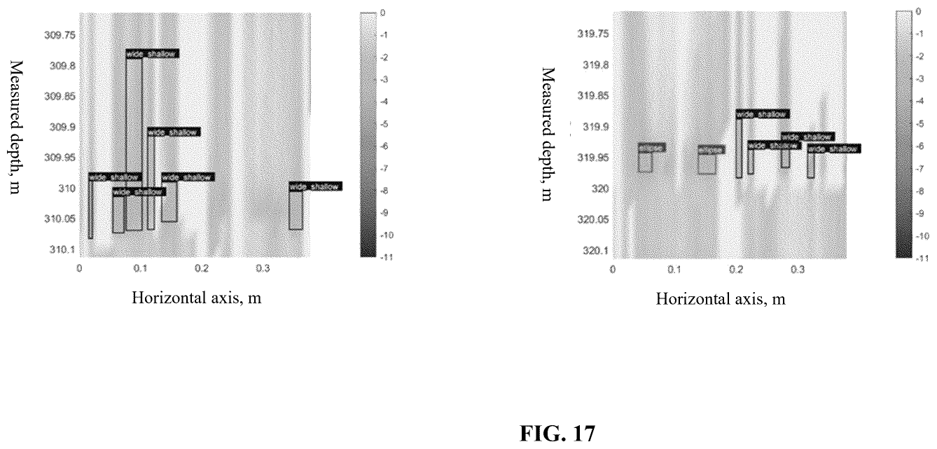

A previously generated pitting-depth heatmap is annotated according to classification annotation, as shown in FIG. 17.

FIG. 17 is a classification annotation diagram of a pitting-depth heatmap according to some embodiments of the present disclosure.

In FIG. 17, the pitting defect of the shallow hemisphere is annotated as wide_shallow. The pitting defect of the hemisphere is annotated as an ellipse. The pitting defect of the deep hemispherical is annotated as narrow_depth.

In 240, introducing a YOLOv8 intelligent image detection model, adding a BAM for enhancing network attention to the pitting region, replacing a BN in the YOLOv8 intelligent image detection model with a BCN to improve training effect, and replacing a CIOU in the YOLOv8 intelligent image detection model with an improved bounding box regression manner Shape-IoU to improve detection capability for irregular pitting regions, thereby obtaining an improved BBI-YOLOv8 intelligent image detection model.

The YOLOv8 intelligent image detection model refers to an initial model used for training to obtain the BBI-YOLOv8 intelligent image detection model.

In some embodiments, the YOLOv8 intelligent image detection model may be a machine learning model.

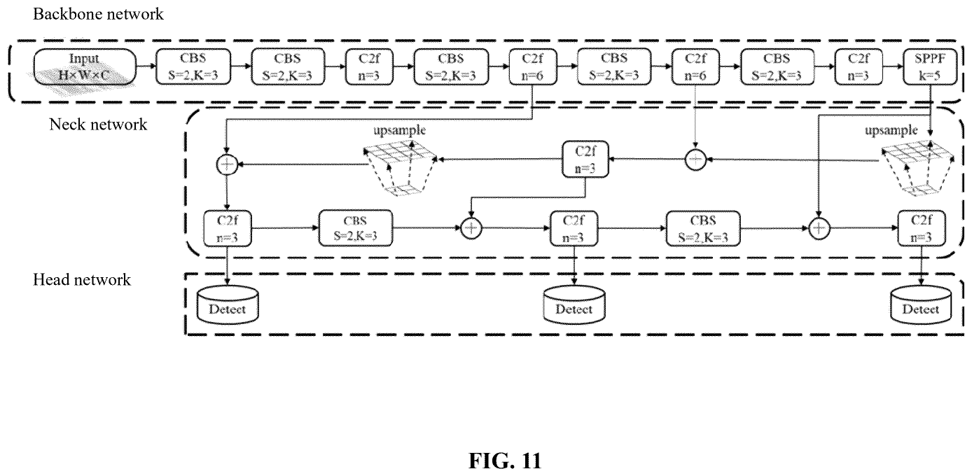

FIG. 11 is a PyTorch framework diagram of YOLOv8 according to some embodiments of the present disclosure.

Embodiments of the present disclosure provide a technique for generating images based on the caliper logging data and a method using a convolutional neural network (CNN) for pitting image recognition and residual strength calculation based on the multi-arm caliper logging data of the inner wall of the tubulars. As shown in FIG. 11, CNN learning is implemented based on the PyTorch framework of the YOLOv8 intelligent image detection model. The PyTorch framework includes a backbone network, a neck network, and a head network. The backbone network is configured to convolve a single-frame pitting-depth heatmap into multi-scale “shape feature maps”. The neck network is configured to perform cross-layer concatenation and fusion of multi-layer feature maps, thereby preserving both shallow edges and deep semantics. The head network is configured to output the pitting region, the confidence level, and the pitting type simultaneously using the fused features, thereby implementing pitting region detection.

An overall structure of the YOLOv8 intelligent image detection model includes a CBS module, a C2f module, and an SPPF module.

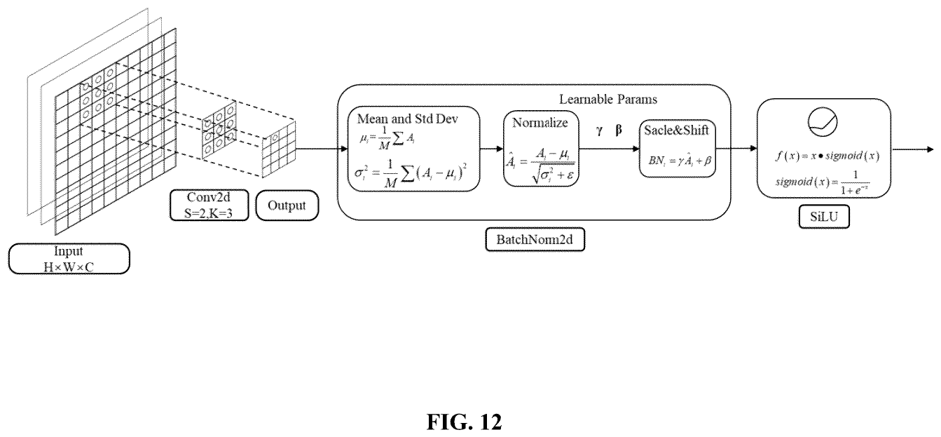

FIG. 12 is a framework flowchart of a CBS module according to some embodiments of the present disclosure.

In some embodiments, as shown in FIG. 12, the CBS module includes three parts: a two-dimensional convolution, a BN, and a Sigmoid Linear Unit (SiLU) activation function.

In some embodiments, the two-dimensional convolution extracts features (e.g., pitting-depth heatmap distribution, edges of the pitting region) of an input image. BatchNorm performs batch normalization on an input (e.g., features extracted by the two-dimensional convolution) via Mean & Std Dev, normalizes the input into a standard normal distribution via Normalize, and then stretches/shifts the standard distribution to a numerical range required by the network by learning a scale parameter y and an offset parameter β to prevent gradient vanishing or explosion. The activation function SiLU combines advantages of a sigmoid function and a linear function to perform nonlinear transformation on an output result.

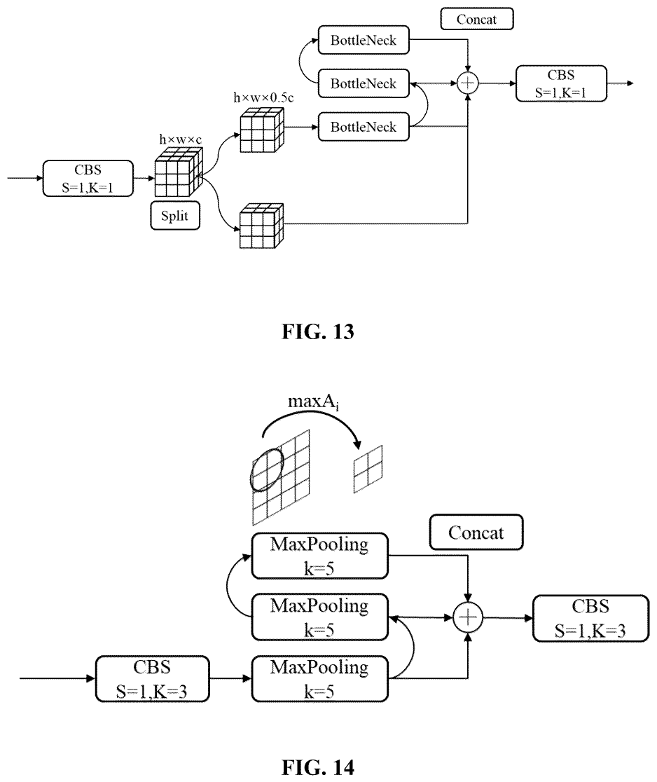

FIG. 13 is a framework flowchart of a C2f module according to some embodiments of the present disclosure.

In some embodiments, as shown in FIG. 13, an input image (i.e., an image in the planar image sequence) is first processed by the CBS module. An output feature image is then split into two halves along a dimension c. One half enters a series of the BottleNeck modules, where each BottleNeck module is formed by two CBS (S=1, K=3) modules in series. An output result of each BottleNeck layer is concatenated before a final CBS module to achieve feature fusion.

FIG. 14 is a framework flowchart of an SPPF module according to some embodiments of the present disclosure.

In some embodiments, as shown in FIG. 14, the input image is first processed by the CBS module. The output feature image is then input into three MaxPooling layers in series. The output result of each BottleNeck layer is concatenated before the final CBS module to achieve feature fusion.

It is to be understood that the YOLOv8 intelligent image detection model implements feature extraction of images through the backbone network, and then implements cross-layer fusion of various features through the SPPF module, the C2f module, and the neck network. Target detection is performed through dual-path prediction and the CNN. Cascade and pyramid concepts are also introduced to accelerate model training efficiency.

The BAM refers to a module configured to enable a model to automatically suppress background scratches and focus on real pitting regions.

To enhance an attention capability of the BBI-YOLOv8 intelligent image detection model to dimensions of the pitting region and reduce misjudgment in region division caused by mutual stacking and interleaving of pitting regions, the present disclosure proposes using a simple and lightweight BAM. The BAM simultaneously introduces a channel attention mechanism and a spatial attention mechanism, allowing the BBI-YOLOv8 intelligent image detection model to adaptively and selectively enhance or weaken feature responses of different channels to improve sensitivity to important information.

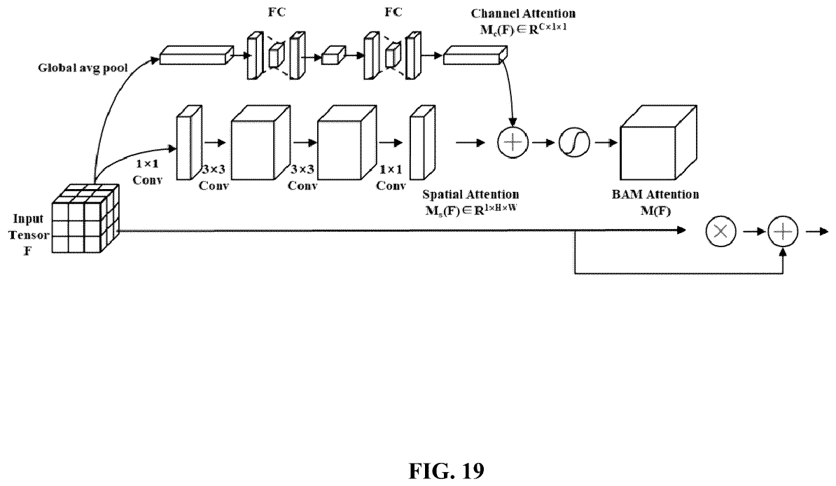

FIG. 19 shows a basic structure of BAM, where FC refers to a Fully Connected Layer. As shown in FIG. 19, an input feature map F (Input Tensor F) is split into two paths. An upper path obtains a channel weight (Channel Attention) Mc(F)∈R^{C×1×1} through global average pooling, 1×1 convolution for dimensionality reduction, ReLU, and 1×1 convolution for dimensionality increase. A lower path obtains a spatial weight (Spatial Attention) Ms(F)∈R^{1×H×W} through 1×1 convolution for channel reduction, 3×3 convolution for spatial context aggregation, and 1×1 convolution for dimensionality increase. Mc(F) and Ms(F) are added pixel by pixel, and a C×H×W joint attention map (BAM Attention) M(F) is generated through Sigmoid. Different from general attention mechanisms, BAM calculates an attention map M(F)∈R^{C×H×W} by integrating a channel attention result M_{c}(F)∈R^{C×1×1} and a spatial attention result Mₛ(F)∈R^{1×H×W}.

$$M ( F ) = sigmoid ( {M}_{c} ( F ) + {M}_{s} ( F ) )$$

In the formula, sigmoid is a function used to generate joint attention map.

A spatial attention calculation formula is:

$$M ( F ) = BN ( {conv}_{{}_{3}}^{{}_{1 \times 1}} ( con {v}_{2}^{3 \times 3} ( c o n {v}_{1}^{3 \times 3} ( c o n {v}_{0}^{1 \times 1} ( F ) ) ) ) )$$

In the formula, conv represents a convolution operation, a superscript represents a convolution filter size, and a subscript represents a convolution order. A convolution kernel with a size of 1 is used to reduce a count of channels. A convolution kernel with a size of 3 is used to aggregate contextual information through a larger receptive field.

The BCN refers to a function configured to mitigate edge drift of the pitting region caused by small-batch training and improve contour accuracy of the pitting region.

The BN in the CBS module does not consider an impact of channel alignment. This may cause the model to lose certain features of image channels. To make the model pay more attention to relationships between different channels and effectively extract feature images, the BCN is proposed. The BCN combines advantages of the BN and a Layer Normalization (LN), simultaneously considering batch, channel, height, and width of a pitting image.

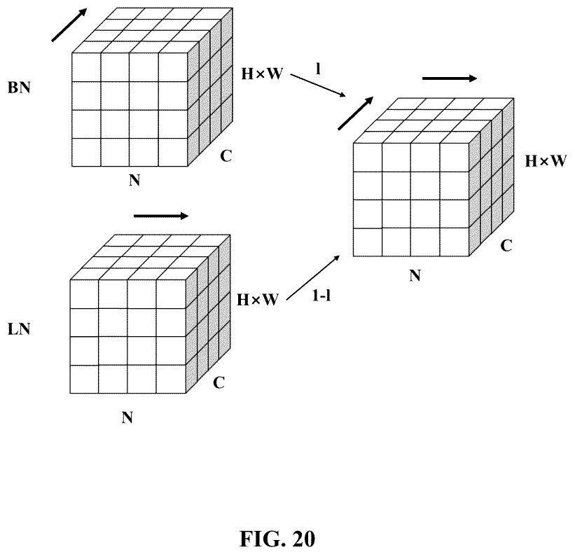

FIG. 20 is a normalization flowchart of BCN for a feature image according to some embodiments of the present disclosure.

FIG. 20 shows a normalization process of BCN for a feature image. N, C, H, and W represent batch, channel, spatial height, and width dimensions, respectively. The BN calculates a mean and a variance along (N, H, W) dimensions. The LN calculates a mean and a variance along (C, H, W) dimensions. Finally, normalized outputs are combined according to adaptive parameters, thereby improving robustness of the model for processing feature images.

BN in BCN calculates an average value μ1 and a variance σ1 of input features along (N, H, W) directions:

$${μ}_{1} = \frac{1}{n} {\sum }_{i = 1}^{n} {x}_{i} \\ {σ}_{1} = \sqrt{\frac{1}{n} {\sum }_{i = 1}^{n} {( {x}_{i} - {μ}_{1} )}^{2}}$$

Similarly, LN calculates an average value μ2 and a variance σ2 of input features along (C, H, W) directions.

Normalization is then performed using (μ1, σ1) and (μ2, σ2), respectively:

$${\overline{x}}_{1} = \frac{( {x}_{i} - {μ}_{1} )}{\sqrt{{σ}_{1}^{2} + ε}} \\ {\overline{x}}_{2} = \frac{( {x}_{i} - {μ}_{2} )}{\sqrt{{σ}_{2}^{2} + ε}}$$

To combine normalized outputs, an additional learning parameter is introduced. Typically, ι is set to 0.9:

$$\overline{y} = ι {\overline{x}}_{1} + ( 1 - ι ) {\overline{x}}_{2}$$

Finally, a scale parameter γ and an offset parameter β are set to obtain an output result:

$$B C N = γ \overline{y} + β$$

In complex situations, the BCN function has better robustness compared to other normalization functions such as BN, LN, IN (Instance Normalization), and GN (Group Normalization), and can better accomplish the task of pitting region detection and type identification in the present disclosure.

The BN refers to a function that alleviates variable shift, accelerates network convergence, and improves generalization ability.

The improved bounding box regression manner may also be referred to as an improved bounding box regression loss function.

In some embodiments, the improved bounding box regression loss function adds a shape penalty term to an irregular box.

The CIOU refers to a bounding box regression loss function that does not add a shape penalty term to an irregular box.

To further enhance the model's ability to capture edge features of the pitting region, an improved bounding box regression manner Shape-IoU is proposed to replace the complete intersection over union (CIOU) loss function in the original YOLOv8 model. While considering the geometric relationship between a ground truth box and a predicted box, the Shape-IoU also incorporates the influence of inherent attributes of the bounding box (such as shape and size) on bounding box regression, thereby making the bounding box regression more accurate.

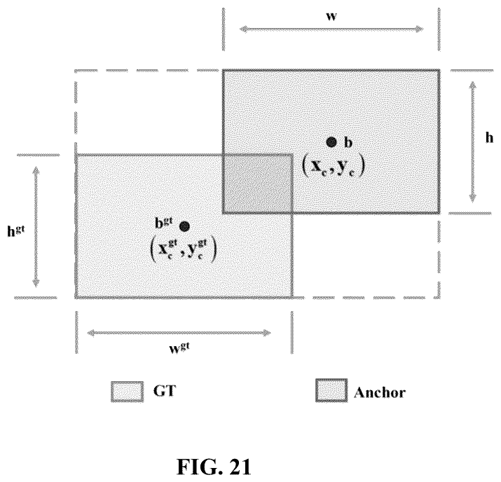

FIG. 21 is a schematic diagram of Shape-IoU regression according to some embodiments of the present disclosure.

As shown in FIG. 21, GT is the ground truth box boundary, and Anchor is the predicted box boundary. Weight coefficients ww and hh in the horizontal direction and the vertical direction are set as follows:

$$\{ \begin{matrix}w w = \frac{2 \times {( {w}^{gt} )}^{scale}}{{( {w}^{gt} )}^{scale} + {( {h}^{gt} )}^{s c a l e}} \\ h h = \frac{2 \times {( {h}^{gt} )}^{scale}}{{( {w}^{gt} )}^{scale} + {( {h}^{gt} )}^{s c a l e}}\end{matrix}$$

In the formula: w^{gt} is a width of the ground truth box, h^{gt} is a height of the ground truth box, and scale is a scale factor that depends on a size of a dataset, generally ranging from 0 to 1.5.

Thus, there are:

$${distance}^{shape} = \frac{h h \times {( {x}_{c} - {x}_{c}^{gt} )}^{2}}{{c}^{2}} + \frac{w w \times {( {y}_{c} - {y}_{c}^{gt} )}^{2}}{{c}^{2}}$$

In the formula:

$${x}_{c} - {x}_{c}^{gt}$$

is a difference in abscissa,

$${y}_{c} - {y}_{c}^{gt}$$

is a difference in ordinate, and c is a proportional coefficient that depends on a ratio of an actual size of an image to a pixel size.

Then calculate:

$$IoU = \frac{\vert B ⋂ {B}^{gt} \vert}{\vert B ⋃ {B}^{gt} \vert} \\ {Ω}^{s h a p e} = {\sum }_{t = w , h} {( 1 - {e}^{- {ω}_{t}} )}^{4}$$

In the formula:

$$\{ \begin{matrix}{w}_{w} = h h \times \frac{\vert w - {w}^{gt} \vert}{max ( w , {w}^{gt} )} \\ {w}_{h} = w w \times \frac{\vert h - {h}^{gt} \vert}{max ( h , {h}^{gt} )}\end{matrix}$$

Finally, the bounding box regression loss function is obtained as:

$${L}_{shape - IoU} = 1 - IoU + {distance}^{shape} + 0.5 {Ω}^{shape}$$

Compared to the CIOU bounding box regression loss function of YOLOv8, Shape-IoU has stronger edge recognition capability. In complex environments, it is more adept at capturing irregular, blurred, and small-target pitting objects, thereby better dynamically optimizing the loss weight of the pitting bounding box to improve the detection performance of the model.

The irregular pitting region refers to the pitting region with an irregularly shaped contour.

The improved BBI-YOLOv8 intelligent image detection model refers to an initial model used for training the intelligent pitting detection model.

Pitting detection on an inner wall of the tubulars based on the YOLOv8 intelligent image detection model includes two parts. First, each pitting region is divided, and then the pitting type of each divided pitting region is identified. Before this, label work needs to be performed on original image samples (i.e., the planar image sequence) to train the model. Therefore, rules for dividing pitting regions and pitting types need to be formulated, and the improved YOLOv8 intelligent image detection model adapted thereto needs to be formulated to improve recognition accuracy. For this purpose, the present disclosure proposes the following improvements:

1) The pitting type classification scheme is designed for making image sample labels. Samples are divided into a training set, a test set, and a validation set to train the model, and a premise is provided for subsequently calculating the residual strength of the pitting region.

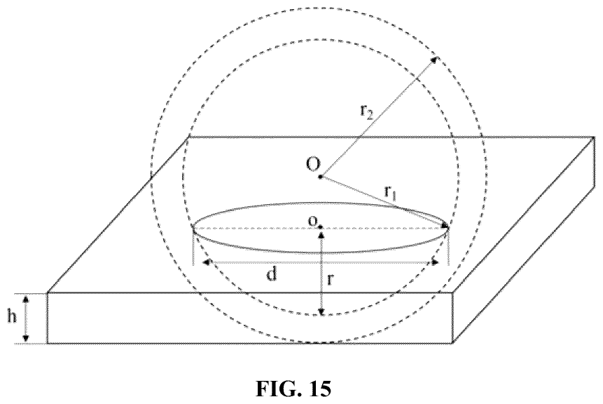

To evaluate the corrosion integrity of the above-mentioned tubing string images, pitting defects need to be classified based on a width and a height of a detection region and the pitting depth. Although multiple standards classify pitting shapes of metals and alloys, most are based on visual inspection and lack strict numerical specifications. For this purpose, a simplified scheme for pitting shape classification that strictly follows the lateral opening size (width), a longitudinal opening size (height), and the pitting depth of pitting is proposed. A pitting defect shape is approximated as a spherical-like shape, and a stress concentration factor K is introduced to calculate the residual strength of the tubulars after pitting occurs. A simplified model thereof is shown in FIG. 15.

FIG. 15 is a diagram of a simplified model of a residual strength of the tubulars according to some embodiments of the present disclosure.

In FIG. 15, d is an opening diameter (mm) when the pitting region is approximated as a hemisphere, satisfying:

$$d = \{ \begin{matrix}\sqrt{( 8 {rr}_{1} - 4 {r}^{2} )} , & ( Shallow hemispherical , Deep hemispherical ) \\ 2 r = 2 {r}_{1} , & ( Hemispherical )\end{matrix}$$

r₂ is a radius (mm) of a concentric circle tangent to an outer wall of the tubulars with O as the center, representing an inscribed circle of a pitting target detection box. When the detection box has a width and a height of (w, h), r₂=min (w, h).

r₁ is a radius (mm) of the pitting pit, satisfying:

$${r}_{1} = {r}_{2} + r - h$$

h is a theoretical wall thickness (mm) of the tubulars.

r is the pitting region depth (mm), representing an average depth of entire pitting pit region in the pitting target detection region:

$$r = \frac{1}{n} {\sum }_{i = 1}^{n} ( {r}_{i} - h )$$

At this time, a stress σ around the pitting pit is:

$$σ = {σ}_{0} [ 1 + \frac{( 4 - 5 μ ) {r}_{1}^{3}}{( 14 - 10 μ ) {d}^{3}} + \frac{9 {r}_{1}^{5}}{( 14 - 10 μ ) {d}^{5}} ]$$

In the formula: σ0 is an initial axial stress (MPa); μ is a Poisson's ratio of the tubulars; and d is a distance (mm) from any point on the pipe wall to an axis center o of the pitting pit.

2) In response to problems such as mutual stacking and interleaving of pitting, a BAM is introduced. The BAM combines advantages of channel attention and spatial attention, adaptively and selectively enhancing or weakening feature responses of different channels to improve sensitivity to important information and enhance detection accuracy of the pitting region.

3) The BCN is used to replace the BN in the CBS module of the YOLOv8 model. The BCN combines advantages of the BN and the LN, simultaneously considering the batch, the channel, the height, and the width of the pitting image, integrating multi-scale feature information, and enhancing feature representation of the pitting region image.

4) In response to a problem that small pitting pits on an inner wall of tubulars are numerous and dense, making detection difficult, an improved bounding box regression manner Shape-IoU is used to replace a complete intersection over union (CIOU) loss function in the original YOLOv8 model. In addition to considering a geometric relationship between a ground truth box and a predicted box, Shape-IoU also considers a shape and a size of an edge box, strengthening edge detection accuracy of the model, thereby enhancing positioning performance and generalization ability of the model.

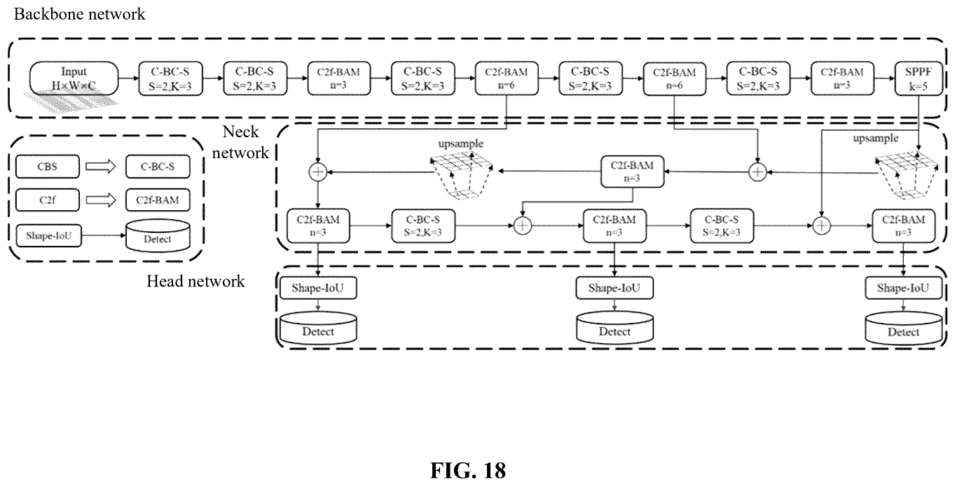

By integrating the above modifications, attention capability of the YOLOv8 intelligent image detection model to spatial dimensions is further enhanced, interference of complex backgrounds, noise, or redundant channels on image features is reduced, recognition sensitivity to boundary shapes and sizes is enhanced, and model iteration efficiency is accelerated. An improved pitting recognition model BBI-YOLOv8 is proposed. An overall architecture thereof is shown in FIG. 18.

FIG. 18 is a diagram of an overall architecture of BBI-YOLOv8 according to some embodiments of the present disclosure.

As shown in FIG. 18, first, a BAM is introduced into the original Backbone network. The module simultaneously introduces a channel attention mechanism and the spatial attention mechanism to perform feature extraction on a pitting image, focusing attention on highly relevant features, thereby improving the model's attention to key information in features of the pitting region and achieving an effect of optimizing model detection performance. Next, in the original CBS module, a BN is improved by adding a LN to obtain a BCN, thereby improving robustness of the model and enabling it to better accomplish the task of pitting region detection and type identification in the present disclosure. Then, in the Head network, the CIOU bounding box loss function in a region detection module is replaced with the Shape-IoU bounding box loss function. While considering a geometric relationship between the ground truth box and the predicted box, Shape-IoU also combines the shape and the size of a bounding box to influence bounding box regression, thereby strengthening the model's ability to capture edge features of the pitting region and making bounding box regression more accurate.

The output result of the improved BBI-YOLOv8 intelligent image detection model includes the following steps:

(1) Obtain depths of all corrosion points in a corrosion target detection region, and determine an average depth of the pitting pit as the pitting region depth r.

(2) Obtain a center coordinate (x, y) and a width and height (w, h) of a corrosion target detection frame, determine the radius r₂ of a circumscribed circle of an approximate hemisphere, the pitting region radius r₁, and an opening length d, and draw a circular detection region frame in an image based on the center and the opening radius to select a corrosion region as a calculation region for residual strength.

(3) Based on the pitting region depth and the opening length, select a formula according to a type to calculate a residual internal pressure resistance strength and a residual external collapse resistance strength of the tubulars in the region, and annotate the strengths in the image.

Taking the test set as an example, the residual external collapse strength and the residual internal pressure resistance strength of each pitting region in sample images are obtained through the above process:

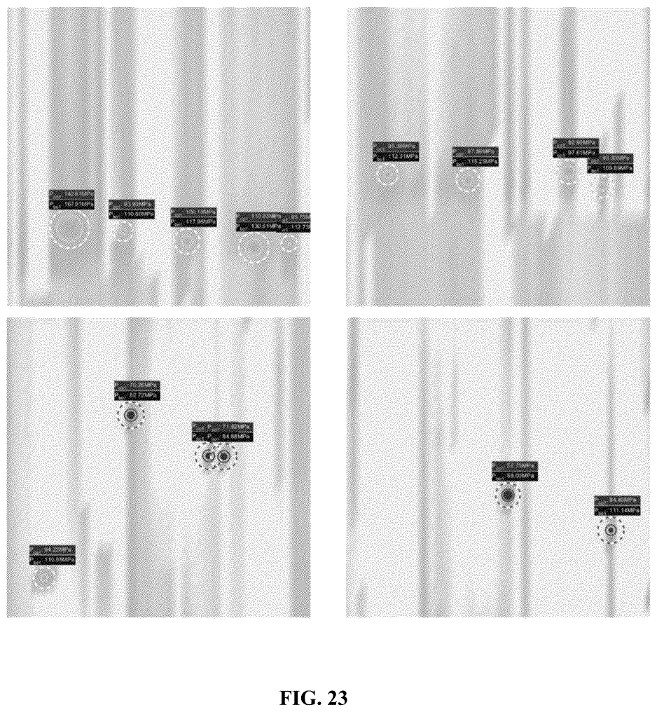

FIG. 23 is a diagram illustrating residual external collapse resistance strength and residual internal pressure resistance strength of each pitting region in sample images according to some embodiments of the present disclosure.

As shown in FIG. 23, light-colored regions are shallow hemispherical pitting defects, dark-colored regions are deep hemispherical pitting defects, solid circles are pitting pit hemispheres, circles are circumscribed circles of pitting pits, and dashed lines are concentric circumscribed circles of pitting pits. As shown in FIG. 23, the residual strength of deep hemispherical pitting defects is generally less than that of shallow hemispherical pitting defects, and decreases with an increase in the opening length and the pitting depth, which is consistent with actual situations and can serve as a reference for residual strength calculation.

In 250, training the improved BBI-YOLOv8 intelligent image detection model using the annotated planar image sequence to obtain an intelligent pitting detection model.

The intelligent pitting detection model refers to a model configured to detect the pitting region. In some embodiments, the intelligent pitting detection model may be a machine learning model. For example, the intelligent pitting detection model may be the CNN.

In some embodiments, the processor may train the improved BBI-YOLOv8 intelligent image detection model based on a plurality of groups of planar image sequences with annotations, thereby obtaining a trained intelligent pitting detection model.

In some embodiments, the processor may input the plurality of groups of planar image sequences into the improved BBI-YOLOv8 intelligent image detection model.

In some embodiments, the intelligent pitting detection model may be obtained by training with a large number of first training samples with the first training labels. A first training sample may include a sample planar image sequence. A first training label corresponding to the first training sample is an annotation of the sample planar image sequence (e.g., the pitting region, the opening length, the average depth).

In some embodiments, the processor may perform multiple rounds of iterative training on the BBI-YOLOv8 intelligent image detection model based on a plurality of first training samples with the first training labels, until an iteration end condition is satisfied, then end the training, thereby obtaining the trained intelligent pitting detection model. At least one round of iterative training includes: selecting one or more first training samples from a training dataset, inputting the one or more first training samples into the BBI-YOLOv8 intelligent image detection model to obtain model prediction outputs corresponding to the one or more first training samples; substituting the model prediction outputs corresponding to the one or more first training samples and the first training labels corresponding to the one or more first training samples into a formula of a predefined loss function to calculate a value of the loss function; and iteratively updating model parameters of the BBI-YOLOv8 intelligent image detection model based on the value of the loss function until the iteration end condition is satisfied, then ending the iteration, thereby obtaining the trained intelligent pitting detection model. The iterative updating of the model parameters of the BBI-YOLOv8 intelligent image detection model may be performed in various manners. For example, the updating may be performed based on a gradient descent manner. The iteration end condition may include convergence of the loss function or reaching an iteration count threshold. The iteration end condition may be convergence of the loss function, reaching a preset iteration count threshold, a value of the loss function being less than a preset function value threshold, etc.

In 260, calculating residual strengths of the pitting regions according to the pitting types, an opening length, an average depth, and a stress concentration factor K of each of the pitting regions.

In some embodiments, the processor may determine the pitting type, the opening length, and an average depth of the pitting region through the intelligent pitting detection model based on the multi-arm caliper logging data, and calculate the residual strength of the pitting region based on the pitting type, the opening length, the average depth, and the stress concentration factor K of the pitting region.

The stress concentration factor K refers to a parameter configured to determine the residual strength of the pitting region.

In some embodiments, the stress concentration factor K is calculated based on the pitting morphology and dimensional characteristics of the pitting region.

The pitting morphology of the pitting region may also be referred to as the pitting type. The dimensional characteristics of the pitting region may include the opening length and the average depth of the pitting region.

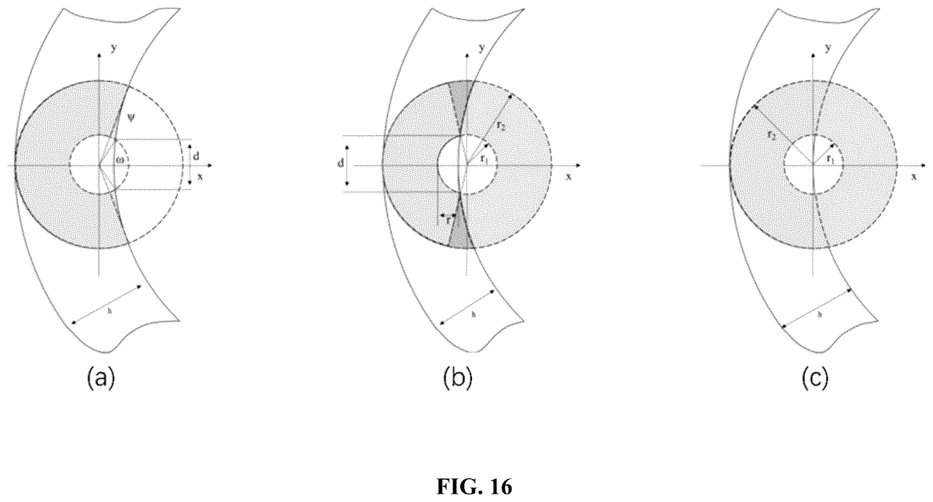

FIG. 16 is a diagram illustrating pitting shapes according to some embodiments of the present disclosure, where (a) is a deep hemispherical pitting defect, (b) is a shallow hemispherical pitting defect, and (c) is a hemispherical pitting defect.

In some embodiments, as shown in FIG. 16, the processor may calculate a residual strength according to different pitting defect types, and calculate stress concentration factors under different pitting pit shapes respectively:

(1) Deep hemispherical pitting defect:

When the width and the height of the pitting region are similar and the pitting depth is relatively deep, a morphology of a pitting defect in the region is approximated as a deep hemispherical pitting defect. In this case, a depth of a pitting hemisphere is greater than a hemisphere radius. The hemisphere radius, an opening diameter, and the pitting depth of this morphology satisfy the following relationship:

$${r}_{1} = \frac{{d}^{2} + 4 {r}^{2}}{8 r}$$

The stress concentration factor of this region is:

$$\frac{π {r}_{2}^{2} - {r}_{2}^{2} arccos ( \frac{r - {r}_{1}}{{r}_{2}} ) + ( r - {r}_{1} ) \sqrt{{r}_{2}^{2} - {( r - {r}_{1} )}^{2}}}{\begin{matrix}( {r}_{2}^{2} - {r}_{1}^{2} ) ( π - arccos ( \frac{r - {r}_{1}}{{r}_{2}} ) ) - {r}_{1}^{2} ( arccos ( \frac{r - {r}_{1}}{{r}_{2}} ) - \\ arccos ( \frac{r - {r}_{1}}{{r}_{1}} ) ) + {( r - {r}_{1} )}^{2} ( tan arccos ( \frac{r - {r}_{1}}{{r}_{2}} ) - \\ tan arccos ( \frac{r - {r}_{1}}{{r}_{1}} ) ) + \frac{{r}_{1}^{2} ( 4 w - 5 w μ + 3 {r}_{1}^{2} v )}{7 - 5 μ}\end{matrix}} \cdot \frac{27 - 15 μ}{14 - 10 μ}$$

Where:

$$w = π - arccos ( \frac{r - {r}_{1}}{{r}_{1}} ) - \frac{{r}_{1} ( sin arccos ( \frac{r - {r}_{1}}{{r}_{2}} ) - sin arccos ( \frac{r - {r}_{1}}{{r}_{1}} ) )}{r - {r}_{1}} - \frac{{r}_{1} ( π - arccos ( \frac{r - {r}_{1}}{{r}_{2}} ) )}{{r}_{2}} + \frac{3 ( arccos ( \frac{r - {r}_{1}}{{r}_{2}} ) - arccos ( \frac{r - {r}_{1}}{{r}_{1}} ) )}{4 - 5 μ}$$

$$v = \frac{\begin{matrix}3 sin arccos ( \frac{r - {r}_{1}}{{r}_{1}} ) - 3 sin arccos ( \frac{r - {r}_{1}}{{r}_{2}} ) + \\ {sin}^{3} arccos ( \frac{r - {r}_{1}}{{r}_{2}} ) - {sin}^{3} arccos ( \frac{r - {r}_{1}}{{r}_{1}} )\end{matrix}}{3 {( r - {r}_{1} )}^{3}} + \frac{π - arccos ( \frac{r - {r}_{1}}{{r}_{2}} )}{{r}_{1}^{3}} - \frac{π - arccos ( \frac{r - {r}_{1}}{{r}_{2}} )}{{r}_{2}^{3}}$$

The pitting shape thereof is as shown in FIG. 16(a).

(2) Shallow hemispherical pitting defect:

When the width and the height of the pitting region are similar, and the pitting depth is relatively shallow, the morphology of the pitting defect in the region is approximated as the shallow hemispherical pitting defect. In this case, the depth of the pitting hemisphere is less than the hemisphere radius. The hemisphere radius, the opening diameter, and the pitting depth of this morphology satisfy the following relationship:

$${r}_{1} = \frac{{d}^{2} + 4 {r}^{2}}{8 r}$$

The stress concentration factor of this region is:

$$\frac{{r}_{2}^{2} arccos ( \frac{{r}_{1} - r}{{r}_{2}} ) - ( {r}_{1} - r ) \sqrt{{r}_{2}^{2} - {( {r}_{1} - {r}_{2} )}^{2}}}{\begin{matrix}{r}_{2}^{2} arccos ( \frac{{r}_{1} - r}{{r}_{2}} ) - {r}_{1}^{2} arccos ( \frac{{r}_{1} - r}{{r}_{1}} ) - \\ {( {r}_{1} - r )}^{2} ( tan arccos ( \frac{{r}_{1} - r}{{r}_{2}} ) - tan arccos ( \frac{{r}_{1} - r}{{r}_{1}} ) ) + \\ \frac{{r}_{1}^{3} ( 4 m - 5 m μ + 3 {r}_{1}^{2} n )}{7 - 5 μ}\end{matrix}} \cdot \frac{27 - 15 μ}{14 - 10 μ}$$

Where:

$$m = \frac{sin arccos ( \frac{{r}_{1} - r}{{r}_{2}} ) - sin arccos ( \frac{{r}_{1} - r}{{r}_{1}} )}{{r}_{1} - r} + \frac{arccos ( \frac{{r}_{1} - r}{{r}_{1}} )}{{r}_{1}} - \frac{arccos ( \frac{{r}_{1} - r}{{r}_{2}} )}{{r}_{2}}$$

$$n = \frac{\begin{matrix}3 sin arccos ( \frac{{r}_{1} - r}{{r}_{2}} ) - 3 sin arccos ( \frac{{r}_{1} - r}{{r}_{1}} ) - \\ {sin}^{3} arccos ( \frac{{r}_{1} - r}{{r}_{2}} ) + {sin}^{3} arccos ( \frac{{r}_{1} - r}{{r}_{1}} )\end{matrix}}{3 {( {r}_{1} - r )}^{3}} + \frac{arccos ( \frac{{r}_{1} - r}{{r}_{1}} )}{{r}_{1}^{3}} - \frac{arccos ( \frac{{r}_{1} - r}{{r}_{2}} )}{{r}_{2}^{3}}$$

The pitting shape thereof is as shown in FIG. 16(b).

(3) Hemispherical pitting defect:

When the width and the height of the pitting region are similar and the pitting depth is relatively moderate, the morphology of the pitting defect in the region is approximated as the hemispherical pitting defect. In this case, the depth of the pitting hemisphere is equal to the hemisphere radius, i.e.:

$${r}_{1} = r = \frac{d}{2}$$

The stress concentration factor of this region is:

$$\frac{\frac{27 - 15 μ}{14 - 10 μ}}{\begin{matrix}1 + ( \frac{27 - 15 μ}{14 - 10 μ} \frac{5 - 4 {μ}^{2}}{( 6 - 4 μ ) ( 1 + μ )} - 2.5 ) \frac{{r}_{1}^{3}}{{h}^{3}} - \\ ( \frac{27 - 15 μ}{14 - 10 μ} \frac{5 - 4 {μ}^{2}}{( 6 - 4 μ ) ( 1 + μ )} - 1.5 ) \frac{{r}_{1}^{5}}{{h}^{5}}\end{matrix}}$$

The pitting morphology thereof is shown in FIG. 16(c).

In some embodiments of the present disclosure, calculating the stress concentration factor K based on the pitting morphology and the dimensional characteristics of the pitting region can convert the “morphology+dimension” of pitting into a stress magnification factor in one step, achieving real-time conversion from geometry to mechanics.

The residual strength refers to a parameter that reflects a maximum pressure a pipeline containing pitting defects can withstand.

In some embodiments, the processor may determine a ratio of the stress concentration factor to an original strength of an entire tubing string as the residual strength.

In some embodiments, the processor may further calculate the stress concentration factor K for each pitting region based on the detection result of the pitting region. The processor may calculate the residual strength of the pitting region based on the pitting type and the geometrical characteristics, combined with the mechanical model.

The detection result refers to a result output by the intelligent pitting detection model after detecting the planar image sequence.

In some embodiments, the detection result may include the pitting type, the opening length, and the depth information (e.g., the average depth).

The geometrical characteristics may also be referred to as the dimensional characteristics. For a description of the dimensional characteristics, refer to related descriptions above.

The mechanical model refers to a model capable of calculating a residual strength of a pitting region based on the stress distribution of the tubulars. For example, the mechanical model may be an American Petroleum Institute (API) thin-walled cylinder strength formula. The stress concentration factor K is used as a denominator and directly multiplied by an original internal pressure resistance strength or an original external collapse resistance strength to obtain the residual strength of the tubulars containing pitting defects.

In some embodiments, the processor may calculate the residual strength of the pitting region based on the stress concentration factor K, the pitting type and the geometrical characteristics of the pitting region, combined with the mechanical model. In some embodiments, by combining K with the API standard internal pressure resistance and external collapse resistance strengths, a calculation formula for the residual strength of tubulars considering pitting is obtained.

A residual external collapse resistance strength of the tubulars is:

$${P}_{co 1} = {P}_{o} \cdot \frac{1}{K} = \frac{2 {σ}_{y}}{K} \cdot \frac{\frac{R}{h} - 1}{{( \frac{R}{h} )}^{2}}$$

A residual internal pressure resistance strength of the tubulars is:

$${P}_{bo 1} = {P}_{bo} \cdot \frac{1}{K} = \frac{2 {σ}_{y} h}{KR}$$

In the formulas: σ_{y} is a minimum yield strength (MPa) of a material of the tubulars; R is a theoretical outer radius (mm) of the tubulars.

In some embodiments, the processor may perform statistics on residual strengths of pitting regions to obtain the residual strength of the entire tubing string. The processor may compare the residual strength of the entire tubing string with an original strength of the entire tubing string to evaluate a corrosion degree and safety of the entire tubing string. The processor may provide a calculation result of the residual strength for tubing string corrosion evaluation and decision support. The original strength refers to a theoretical pressure resistance strength of a brand-new tubulars.

In some embodiments, the processor may perform statistics on residual strengths of pitting regions. The processor may use a minimum value among residual strengths of all pitting regions in the entire tubing string as the residual strength of the entire tubing string.

The entire tubing string refers to a continuous tubular structure formed by connecting one or more tubulars via threads or welding.

In some embodiments, a larger difference between the residual strength of the entire tubing string and the original strength of the entire tubing string indicates a higher corrosion degree and lower safety.

In some embodiments of the present disclosure, based on the detection result of the pitting region, the stress concentration factor K is determined. Combined with the mechanical model, the residual strength of the pitting region is calculated. Subsequently, the residual strength of the entire tubing string is obtained. The corrosion degree and safety of the entire tubing string are evaluated. This enables immediate judgment of corrosion severity and precise identification of load-bearing bottlenecks.

In some embodiments, the processor may further obtain real-time operating condition data of the pitting region. Based on the residual strength of the pitting region and the real-time operating condition data, the processor may determine a corrosion risk value of the pitting region. Based on the corrosion risk value, the processor may generate a repair instruction. The repair instruction includes a repair position, a spraying material, and a spraying volume. The processor may control a downhole repair robot to move to the repair position and spray the spraying material onto the repair position according to the spraying volume.

The real-time operating condition data refers to related environmental data of the pitting region.

For example, the real-time operating condition data may include pressure, temperature, composition of fluid flowing through the pitting region, concentration of the fluid, etc.

In some embodiments, the processor may obtain the real-time operating condition data via a sensor. For example, the sensor may include a pressure sensor, a temperature sensor, a chemical substance sensor, etc.

The corrosion risk value refers to a parameter describing a magnitude of corrosion risk of a pitting region.

In some embodiments, a larger corrosion risk value indicates a greater corrosion risk for the pitting region.

In some embodiments, the processor may determine the corrosion risk value of the pitting region based on the residual strength of the pitting region and real-time operating condition data in various ways. For example, the processor may determine a weighted sum of the residual strength of the pitting region and an operating condition risk value as the corrosion risk value. The operating condition risk value refers to a cosine similarity between the real-time operating condition data and standard operating condition data. The standard operating condition data may be preset by the technician based on experience. Weights for the weighted sum may be preset by the technician based on experience.

The repair instruction refers to an instruction for repairing the pitting region.

In some embodiments, the repair instruction may include the repair position, the spraying material, the spraying volume, etc.

The repair position refers to a position where a pitting region is located.

In some embodiments, the processor may use a position of the pitting region output by the model as the repair position.

The spraying material refers to a material used for repairing a pitting region. For example, the spraying material may be an epoxy resin-based composite material, a corrosion-resistant alloy powder, a high-performance metal-ceramic composite material, etc. The spraying volume refers to a volume of the spraying material used for repairing the pitting region.

In some embodiments, the processor may determine the spraying material and the spraying volume by querying a first preset table based on the corrosion risk value. The first preset table may include a relationship between the corrosion risk value and the spraying material and the spraying volume. In some embodiments, the first preset table may be preset by the technician based on experience.

The downhole repair robot refers to an execution component used for repairing the pitting region.

In some embodiments, the processor may control the downhole repair robot to move to the repair position, and spray a spraying material to the repair position according to the spraying volume to repair the pitting region.

In some embodiments of the present disclosure, repair parameters (e.g., spraying material, volume) are automatically generated based on the residual strength of the pitting region and real-time operating condition data, guiding the downhole robot for precise operation. This can effectively avoid misjudgment due to manual experience and improve repair efficiency and reliability. Meanwhile, through differentiated repair strategies (e.g., protective spraying for shallow pitting, structural patching for deep pitting), resource allocation is optimized under the premise of ensuring safety, thereby reducing maintenance costs.

In some embodiments, the processor may also determine an operation parameter based on the corrosion risk value; drive a motor of a production pump to adjust a rotational speed of the production pump to a target rotational speed; and drive a valve arm or a valve plate to adjust an opening of a wellhead throttle valve to a target opening.

The operation parameter refers to a parameter during operation of an oil well.

In some embodiments, the operation parameter may include the target rotational speed of the production pump or a target opening of the wellhead throttle valve. The production pump refers to a volumetric or centrifugal pump device configured to suction fluid from the tubulars and adjust a displacement rate with the rotational speed. The wellhead throttle valve refers to an adjustable throttling element configured to control wellhead back pressure and production by changing an opening of the valve plate. The target rotational speed refers to an expected rotational speed value of the production pump. The target opening refers to an expected opening percentage of the wellhead throttle valve.

In some embodiments, the processor may determine the operation parameter by querying a second preset table based on the corrosion risk value. The second preset table may include a relationship between the corrosion risk value and the operation parameter. In some embodiments, the second preset table may be determined by the technician based on historical data.

Merely by way of example, the technician may include, in the second preset table, operation parameters under which, for a same corrosion risk value in historical data, the corrosion risk value after operation is significantly reduced (e.g., a difference between the corrosion risk values before and after operation is greater than a threshold) compared to before operation.

The valve arm refers to a component configured to transmit force to the valve plate to change a fluid flow area.

The valve plate refers to a blocking member configured to change a fluid flow area.

In some embodiments of the present disclosure, when the pitting risk increases, non-intrusive pressure reduction and load shedding are used to delay corrosion development, which can avoid sudden failure. Meanwhile, continuous production in the wellbore is maintained, reserving a window for planned repair.

In some embodiments, the processor may also periodically execute the following steps based on a preset period: determine a residual strength of a well section based on residual strengths of all pitting regions within the well section; determine a strength decline rate based on the residual strength of the well section in a current period and the residual strength of the well section in a previous period; in response to the strength decline rate being higher than a rate threshold, obtain real-time operating condition data of the well section over the preset period; and adjust a spraying material and a spraying volume injected into the well section based on the real-time operating condition data over the preset period.

The preset period refers to a period for adjusting the spraying material and the spraying volume.

In some embodiments, the preset period may be preset by the technician based on experience.

In some embodiments, the processor may also determine the residual strength of the entire tubing string over a future period by using a prediction model based on a type of the oil well, residual strength of at least one preset period, real-time operating condition data of at least one preset period, and spraying material and spraying volume injected into the well section for at least one preset period; and adjust a length of the preset period based on the residual strength of the entire tubing string over the future period.

The type of the oil well refers to a category of the oil well classified based on a composition of produced fluid at a wellhead.

The prediction model refers to a model configured to determine the residual strength of the entire tubing string over a future period.

In some embodiments, the prediction model may be the machine learning model. As another example, the prediction model may be the CNN.

In some embodiments, an input of the prediction model may include the type of the oil well, the residual strength of at least one preset period, the real-time operating condition data of at least one preset period, and the spraying material and the spraying volume injected into the well section for at least one preset period. An output of the prediction model may include the residual strength of the entire tubing string over the future period. The future period refers to one or more periods after a current period.

In some embodiments, the processor may obtain the prediction model by training based on a plurality of second training samples with second training labels.

In some embodiments, a second training sample may include a type of a sample oil well, sample residual strength of at least one preset period, sample real-time operating condition data of at least one preset period, and sample spraying material and sample spraying volume injected into a well section for at least one preset period. The second training sample may be determined by the processor based on historical data. As another example, the second training sample may be a historical type of an oil well, a historical residual strength of at least one preset period, historical real-time operating condition data of at least one preset period, and a historical spraying material and a historical spraying volume injected into a well section for at least one preset period. The second training label may be an actual residual strength of the entire tubing string over a future period under the second training sample.

In some embodiments, the processor may perform multiple rounds of iterative training on an initial prediction model based on the plurality of second training samples with the second training labels, until a training end condition is met, to obtain a trained prediction model. At least one round of iterative training includes: selecting one or more second training samples from a training dataset; inputting the one or more second training samples into the initial prediction model to obtain model prediction outputs corresponding to the one or more second training samples; substituting the model prediction outputs corresponding to the one or more second training samples and the second training labels corresponding to the one or more second training samples into a formula of a predefined loss function to calculate a value of the loss function; and iteratively updating model parameters of the initial prediction model based on the value of the loss function until the training end condition is met, thereby ending the iteration and obtaining the trained prediction model. The iterative updating of the model parameters of the initial prediction model may be performed in various ways. As another example, the updating may be performed based on a gradient descent manner. The training end condition may be convergence of the loss function, reaching a preset iteration count threshold, a value of the loss function being less than a preset function value threshold, etc.

In some embodiments, the processor may adjust the length of the preset period based on the residual strength of the entire tubing string over the future period. As another example, a faster decline rate of the residual strength of the entire tubing string over the future period corresponds to a shorter length of the preset period.

In some embodiments, the processor may perform linear fitting with time as an independent variable and residual strength as a dependent variable to construct a linear function, and determine a slope of the linear function as the decline rate of the residual strength.

In some embodiments of the present disclosure, integrating historical data and operating condition parameters to predict remaining service life provides a scientific basis for maintenance planning. This supports the formulation of proactive overhaul strategies, avoids unplanned shutdowns, enhances the digital and intelligent level of asset management, and ultimately achieves optimal lifecycle cost.

The well section refers to a partial segment of the oil well.

In some embodiments, the processor divides the oil well into a plurality of well sections based on the preset length. The preset length may be preset by the technician based on experience.

In some embodiments, the processor may determine the residual strength of the well section as the minimum value among the residual strengths of all pitting regions within the well section.

In some embodiments, the processor may first determine a difference between the residual strength of the well section in the previous period and the residual strength of the well section in the current period, and use a ratio of the difference to a length of a single period as the strength decline rate.

The rate threshold refers to a parameter used to determine whether to adjust the spraying material and the spraying volume.

In some embodiments, the rate threshold may be preset by the technician based on experience.

In some embodiments, the processor may adjust the spraying material and the spraying volume injected into the well section by querying a third preset table based on the real-time operating condition data over the preset period. The third preset table includes a relationship between the real-time operating condition data and the spraying material and the spraying volume. In some embodiments, the third preset table may be preset by the technician based on experience.

For example, the processor may determine a target spraying material and a spraying volume by querying a third preset table, and adjust a spraying material and a spraying volume for a current injection well section to the target spraying material and the spraying volume.

In some embodiments of the present disclosure, precise addition of spraying materials for different corrosion environments (e.g., CO₂-dominated or high-temperature environments) can improve protection efficiency, reduce chemical waste, and achieve dual optimization of cost and safety.

In some embodiments of the present disclosure, by optimizing and training a model to identify pitting regions and calculate residual strength, automation and intelligence of pitting detection are achieved. Compared with traditional manual methods, the detection speed is faster, and the results are more accurate and consistent, effectively reducing subjective errors from manual operations. The model can directly extract key parameters of pitting from images and quickly combine the mechanical model to calculate residual strength of the tubing string, meeting the demand for real-time processing of a large amount of data in production. A calculation model combining the pitting type, the dimensional characteristics, and the stress concentration is established, providing a more accurate evaluation basis for tubing string corrosion integrity management and risk warning, and effectively supporting safety production decisions for oil and gas wells. Through real-time and accurate assessment of residual strength of the tubing string, potential corrosion defects and risks can be discovered in advance, providing a theoretical basis for predicting safe life of the tubing string and taking control measures in advance, which helps avoid major accidents such as tubing string failure.

Those of ordinary skill in the art will appreciate that the embodiments described herein are intended to help readers understand the implementation methods of the present disclosure, and it should be understood that the protection scope of the present disclosure is not limited to such specific statements and embodiments. Those of ordinary skill in the art can make various other specific modifications and combinations based on the technical inspirations disclosed in the present disclosure without departing from the essence of the present disclosure, and these modifications and combinations are still within the protection scope of the present disclosure.

What is claimed is:

1. A pitting detection and residual strength calculation method for multi-arm caliper logging data, comprising the following steps:
S1, converting the multi-arm caliper logging data into a three-dimensional model;
S2, performing data cleaning on the three-dimensional model, and performing batch projection transformation to obtain a planar image sequence;
S3, classifying and annotating pitting regions in the planar image sequence according to pitting types to obtain an annotated planar image sequence;
S4, introducing a you only look once vertion 8 (YOLOv8) intelligent image detection model, adding a bottleneck attention module (BAM) for enhancing network attention to the pitting regions, replacing a batch normalization function (BN) in the YOLOv8 intelligent image detection model with a batch channel normalization function (BCN) to improve training effect, and replacing a complete intersection over union loss function (CIOU) in the YOLOv8 intelligent image detection model with an improved bounding box regression manner Shape-aware Intersection over Union (Shape-IoU) to improve detection capability for irregular pitting regions, thereby obtaining an improved Bottleneck Attention Module-Batch Channel Normalization-Shape-IoU (BBI)-YOLOv8 intelligent image detection model;
S5, training the improved BBI-YOLOv8 intelligent image detection model using the annotated planar image sequence to obtain an intelligent pitting detection model; and
S6, calculating residual strengths of the pitting regions according to the pitting types, an opening length, an average depth, and a stress concentration factor K of each of the pitting regions.

2. The pitting detection and residual strength calculation method according to claim 1, wherein the converting the multi-arm caliper logging data into the three-dimensional model includes: mapping the multi-arm caliper logging data into a three-dimensional spatial coordinate system and generating a preliminary three-dimensional caliper model.

3. The pitting detection and residual strength calculation method according to claim 1, wherein the data cleaning includes removing noise data, abnormal values, and measurement errors from the three-dimensional model, and performing smoothing on the three-dimensional model.

4. The pitting detection and residual strength calculation method according to claim 1, wherein the pitting regions are classified into shallow hemispherical, hemispherical, and deep hemispherical according to a morphology of each of the pitting regions, and the opening length, the average depth, and a position of each of the pitting regions are annotated.

5. The pitting detection and residual strength calculation method according to claim 1, wherein the stress concentration factor K is calculated according to a morphology and dimensional characteristics of each of the pitting regions.

6. The pitting detection and residual strength calculation method according to claim 1, wherein the planar image sequence includes a plurality of images converted from measurement results of a multi-arm caliper at different depths and different angles of an oil well.

7. The pitting detection and residual strength calculation method according to claim 1, wherein the calculating the residual strengths of the pitting regions includes:
calculating the stress concentration factor K of each pitting region of the pitting regions according to a detection result of the each pitting region, wherein the detection result includes the pitting type, the opening length, and depth information;
calculating the residual strengths of the pitting regions according to the pitting types and geometrical characteristics in combination with a mechanical model;
statistically analyzing the residual strengths of the pitting regions to obtain a residual strength of an entire tubing string;
comparing the residual strength of the entire tubing string with an original strength of the entire tubing string to evaluate a corrosion degree and safety of the entire tubing string; and
providing a calculation result of the residual strength for tubing string corrosion evaluation and decision support.

8. An intelligent pitting detection system for implementing the pitting detection and residual strength calculation method according to claim 1, wherein the intelligent pitting detection system comprises:
a data conversion module configured to convert the multi-arm caliper logging data into the three-dimensional model;
a data processing module configured to perform the data cleaning on the three-dimensional model and perform the batch projection transformation to obtain the planar image sequence;
a classification and annotation module configured to classify and annotate the pitting regions in the planar image sequence according to the pitting types to obtain the annotated planar image sequence;
an intelligent detection module configured to introduce the YOLOv8 intelligent image detection model, add the BAM, replace the BN in the YOLOv8 intelligent image detection model with the BCN, and replace the CIOU in the YOLOv8 intelligent image detection model with the improved bounding box regression manner Shape-IoU to improve the detection capability for the irregular pitting regions, thereby obtaining the improved BBI-YOLOv8 intelligent image detection model;
a model training module configured to train the annotated planar image sequence using the improved BBI-YOLOv8 intelligent image detection model to obtain the intelligent pitting detection model; and
a strength calculation module configured to calculate the residual strengths of the pitting regions according to the pitting types, the opening length, the average depth, and the stress concentration factor K of each of the pitting regions.

9. The intelligent pitting detection system according to claim 8, wherein the intelligent detection module further includes a pitting region localization module for accurately identifying the pitting regions in images of the planar image sequence and improving robustness of the improved BBI-YOLOv8 intelligent image detection model in complex backgrounds.
